(19) United States
(12) Patent Application Publication
(10) Pub. No.: US 2009/0304312 A1
(43) Pub. Date: Dec. 10, 2009

(54) MOTION GUIDE DEVICE AND ATTACHMENT FOR MOTION GUIDE DEVICE

(75) Inventors: Takuya Horie, Tokyo (JP); Hiroyuki Kishi, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: THK CO., LTD., Shinagawa-ku, Tokyo (JP)

(21) Appl. No.: 12/159,324

(22) PCT Filed: Dec. 25, 2006
(86) PCT No.: PCT/JP2006/325715

§ 371 Date: May 21, 2009

(30) Foreign Application Priority Data
Dec. 26, 2005 (JP) 2005-373459
Sep. 29, 2006 (JP) 2006-269537
Sep. 29, 2006 (JP) 2006-269540

(51) Int. Cl. F16C 29/04; B21D 53/10

(52) U.S. Cl. 384/13; 29/898.03

(57) ABSTRACT

Provided is a motion guide device having a lubricating path usable for both of grease lubrication and oil lubrication.

The motion guide device has a raceway rail 1 and a moving block 2 mounted on the raceway rail 1 slidably via rollers 3 as rolling elements. Onto each moving-directional end of the moving block 2, an endplate 32 is attached which has a direction change path 6 formed therein for circulation of the rollers 3 and a lubricating path 38 formed therein for supplying the rollers 3 with a lubricant. In oil lubrication with use of lubricating oil as the lubricant, a lubricating path piece 39 is fit into the endplate 32 to narrow the lubricating path 38, while in grease lubrication with use of grease as the lubricant, the lubricating path piece 39 is not fit to the endplate 32 so as to widen the lubricating path 38 as compared with that for the oil lubrication.

### TECHNICAL FIELD

The present invention relates to a motion guide device, such as a linear guide, a spline and the like, for guiding linear or curvilinear movement of a moving member such as a table.

### BACKGROUND ART

A motion guide device having rolling elements such as balls or rollers at a guide portion is known as a mechanical elements for guiding linear movement or curvilinear movement of a moving body such as a table and is utilized in various fields including robots, machine tools, semiconductor/liquid crystal manufacturing equipment, medical machines and the like.

A linear guide as one kind of motion guide device has: a raceway rail mounted on a base; and a moving block mounted on the raceway rail relatively movable thereon, and a moving body is mounted on the moving block. In the raceway rail, a rolling-element rolling portion is formed extending in the longitudinal direction of the raceway rail. In the moving block, a loaded rolling-element rolling portion is formed opposed to the rolling-element rolling portion and a rolling-element circulation path is formed for circulating rolling elements. Between the rolling-element rolling portion of the raceway rail and the loaded rolling-element rolling portion of the moving block, the rolling elements are interposed. When the moving block moves relative to the raceway rail, the rolling elements roll between the raceway rail and the moving block to circulate in the rolling-element circulation path.

When such a rolling-type motion guide device is used, it is necessary to assure excellent lubrication, or to form an oil film between the rolling elements and the rolling surfaces to prevent direct contact between metals. If the motion guide device is used without lubricant, the rolling elements and the rolling surfaces are wearing out to cause loss of life to the motion guide device.

There are two types of lubricant, that is, grease (lithium grease, urea grease and the like) and lubricant oil (sliding surface oil, turbine oil, ISOVG 32-68 and the like). The grease and lubricant oil are used in different use environments. For example, the sliding surface oil is used in an environment where coolant of machine tool or the like flies in all directions, and the grease is used in other environments such as high-speed moving portion, vacuum environment and clean room.

As a lubricating method of the motion guide device, there are two methods, that is, a manual supply method using a manual pump or the like and a forced supply method using an automatic pump. For example, in the manual supply method as shown in FIG. 41, a grease gun 165 is used to supply grease to a motion guide device via a nipple 166 periodically. At an endplate 164 attached to an end surface of the moving block, a lubricant supply path is formed linking to the rolling-element circulation path. When the nipple 166 is supplied with grease, the grease is supplied via the lubricant supply path to the rolling elements (see patent document 1, for example). As shown in FIG. 42, the forced supply method is a method of supplying a predetermined amount of lubricant oil periodically with use of an automatic pump, and lubrication is performed mainly with lubricating oil. Also in this forced supply method, like in the manual supply method, the lubricating oil is supplied to the rolling elements via the nipple 166 and lubricant supply path of the endplate 164.

### [Patent Document 1] Japanese Patent Laid-open Publication No. 2005-083500

### [Patent Document 2] Japanese Patent Laid-open Publication No. 2004-353698

### DISCLOSURE OF INVENTION

### Problems to be Solved by the Invention

However, the lubricating oil and grease are different in ease of flowing in the lubricant supply path. The grease is gelatinous and has high viscosity. Therefore, in order to supply grease with low pressure, it is necessary to reduce the resistance of the lubricant supply path. In order to reduce the resistance, the lubricant supply path needs to have larger cross section and smaller length.

Meanwhile, the lubricating oil is in liquid state, has low viscosity and flows in the lubricant supply path smoothly. Therefore, if time has passed after the lubricating oil is supplied to the lubricant supply path intermittently, the lubricating oil flows out of the lubricant supply path due to gravity, and at the next supply time of the lubricating oil, the lubricating oil flows in the empty lubricant supply path. As the motion guide device is used in various positions and a plurality of, such as four, rolling-element circulation paths is provided in the motion guide device, some lubricant supply paths have to be supplied with lubricant against gravity. Besides, in view of influence on the environment in these days, the supply amount of lubricating oil tends to be reduced.

When a small amount of lubricating oil is supplied to the lubricant supply path of large content, there occurs a phenomenon that the lubricant supply path is not filled with the lubricating oil and pressure is not applied, which results in difficulty in supplying the lubricating oil to all rolling-element circulation paths. As the rolling-element circulation paths are independent from each other, all of the rolling-element circulation paths have to be supplied with the lubricant separately. In order to supply the lubricant to all of the rolling-element circulation paths, the content of each lubricant supply path needs to be smaller. On this account, the lubricant supply path needs to have smaller cross section and smaller length.

In other words, in order to use grease as lubricant, the lubricant supply path need to have larger cross section and smaller length, while in order to use lubricating oil as lubricant, the lubricant supply path needs to have smaller cross section and smaller length. If the lubricant supply paths are equal in length, the cross section of the lubricant supply path has to be larger in supply of grease and smaller in supply of lubricating oil. In this way, the required cross section differs completely between the case of lubricating oil supply and the case of grease supply. In the conventional motion guide device, the lubricating path was designed having an area of size appropriate for both of grease lubrication and oil lubrication. However, in view of affects on the environment, as a use amount of lubricant is reduced, designing of the lubricating path applicable to both of grease lubrication and oil lubrication becomes more difficult.

Then, the present invention has an object to supply a motion guide device and an attachment for the motion guide device usable in both of the case of supplying grease and case of supplying lubricating oil.

In the meantime, some endplate is split into plural pieces. For example when two direction change paths cross each other at an endplate, as shown in FIG. 43, a direction change path component 170 of the direction change path is embedded in the endplate 164. If a lubricant supply path 164a for supplying a lubricant is placed over the direction change path component 170 and the endplate 164, the lubricant leaks from a gap 164b between the pieces, which may result in prevention of the lubricant from reaching the rolling-element circulation path. As the endplate 164 and the direction change path component 170 are molded products, the gap 164b is difficult to eliminate.

Further, if the endplate is larger sized with size increase of the motion guide device, the endplate becomes difficult to mold with resin. This may need a larger-sized die and such a die is difficult to form. Even if the die is formed, this leads to increase in cost. For this reason, the inventors have devised a manufacturing method of splitting the endplate into plural pieces, molding the pieces with resin and then connecting the pieces together. However, when the endplate is split into plural pieces, a joint portion of the pieces is placed at some midpoint of the lubricant supply path of the endplate. Then, there occurs a problem that the lubricant is apt to leak from the joint portion.

As shown in FIG. 44, the above-mentioned patent document 2 discloses the invention in which a separate member 168 having a lubricating path groove 167 formed therein is prepared separately from the endplate 169 and the separate member 168 is connected to the endplate 169 thereby to constitute a lubricating path (see patent document 2, claim 1). However, in the invention disclosed in the patent document 2, as the endplate is not split, such a problem that the lubricant leaks from the joint portion of the split endplate pieces cannot be solved.

Then, the present invention has an object to provide a motion guide device capable of preventing leakage of lubricant from a joint portion even if an endplate is divided into plural pieces.

### Means for Solving the Problem

The present invention will now be described below.

In order to solve the above-mentioned problems, the invention of claim 1 is a motion guide device comprising: a raceway member having a rolling-element rolling portion formed thereon; a moving block having a loaded rolling-element rolling portion formed thereon facing the rolling-element rolling portion and having a rolling-element return path extending approximately in parallel with the loaded rolling-element rolling portion; a pair of cover members provided at respective moving-directional ends of the moving block and each having a direction change path connecting the loaded rolling-element rolling portion and the rolling-element return path; a plurality of rolling elements arranged in a rolling-element circulation path including the loaded rolling-element rolling portion, the rolling-element return path and the direction change path; and a lubricating path, provided on at least one of the cover members, for supplying a lubricant to the rolling-element circulation path, the lubricating path being narrowed for oil lubrication using a lubricating oil as the lubricant and being widened for grease lubrication using a grease as the lubricant as compared with the oil lubrication.

The invention of claim 2 is characterized in that, in the motion guide device of claim 1, the at least one of the cover members has a lubricating path piece having formed therein a lubricating path groove which constitutes the lubricating path and a cover member main body having a fitting groove for fitting the lubricating path piece therein, for the oil lubrication using the lubricating oil as the lubricant, the lubricating path is narrowed by fitting the lubricating path piece into the fitting groove of the cover member main body, and for the grease lubrication using the grease as the lubricant, the lubricating path piece is not fit to the fitting groove of the cover member main body to use the fitting groove of the cover member main body as the lubricating path.

The invention of claim 3 is characterized in that, in the motion guide device of claim 1, the at least one of the cover members has a lubricating path piece having formed therein a lubricating path groove which constitutes the lubricating path and a cover member main body having a fitting groove for fitting the lubricating path piece therein, the lubricating path piece includes an oil lubricating piece having a narrow oil lubricating path groove formed therein and a grease lubricating piece having formed therein a grease lubricating path groove that is wider than the oil lubricating path groove, and for the oil lubrication using the lubricating oil as the lubricant, the oil lubricating piece is fit into the cover member main body, while for the grease lubrication using the grease as the lubricant, the grease lubricating piece is fit into the cover member main body.

The invention of claim 4 is characterized in that, in the motion guide device of claim 1, the at least one of the cover members has a lubricating path piece having formed therein a lubricating path groove which constitutes the lubricating path and a cover member main body having a fitting groove for fitting the lubricating path piece therein, the lubricating path groove has a narrow oil lubricating path groove formed on a front surface of the lubricating path piece and a grease lubricating path groove formed on a back surface of the lubricating path piece, the grease lubricating path groove being wider than the oil lubricating path groove, for the oil lubrication using the lubricating oil as the lubricant, the lubricating path piece is fit into the cover member main body to use the oil lubricating path groove of the lubricating path piece as the lubricating path, and for the grease lubrication using the grease as the lubricant, the lubricating path piece is fit into the cover member main body to use the grease lubricating path groove of the lubricating path piece as the lubricating path.

The invention of claim 5 is characterized in that, in the motion guide device of any one of claims 2 to 4, the fitting groove of the cover member main body is formed horizontally symmetrical when seen in an axial direction of the raceway member, the lubricating path piece is split into horizontally symmetrical two parts when seen in the axial direction of the raceway member, and split lubricating path pieces of one kind having a substantially identical shape are fit into both right side and left side of the fitting groove.

The invention of claim 6 is a motion guide device comprising: a raceway member having a rolling-element rolling portion formed thereon; a moving block having a loaded rolling-element rolling portion formed thereon facing the rolling-element rolling portion and having a rolling-element return path extending approximately in parallel with the loaded rolling-element rolling portion; a pair of cover members provided at respective moving-directional ends of the moving block and each having a direction change path connecting the loaded rolling-element rolling portion and the rolling-element return path; a plurality of rolling elements arranged in a rolling-element circulation path including the loaded rolling-element rolling portion, the rolling-element return path and the direction change path; and a lubricating path, provided on at least one of the cover members, for supplying a lubricant to the rolling-element circulation path, wherein at least one of the cover members has a lubricating path piece having formed therein a lubricating path groove which constitutes the lubricating path and a cover member main body having a fitting groove formed therein for fitting the lubricating path piece therein, when the lubricating path piece is not fit into the fitting groove of the cover member main body, the fitting groove of the cover member main body is used as the lubricating path, and when the lubricating path piece is fit into the fitting groove of the cover member main body, the lubricating path is narrowed.

The invention of claim 7 is a lubricating path piece for a motion guide device having: a raceway member having a rolling-element rolling portion formed thereon; a moving block having a loaded rolling-element rolling portion formed thereon facing the rolling-element rolling portion and having a rolling-element return path extending approximately in parallel with the loaded rolling-element rolling portion; a pair of cover members provided at respective moving-directional ends of the moving block and each having a direction change path connecting the loaded rolling-element rolling portion and the rolling-element return path; a plurality of rolling elements arranged in a rolling-element circulation path including the loaded rolling-element rolling portion, the rolling-element return path and the direction change path; and a lubricating path, provided on at least one of the cover members, for supplying a lubricant to the rolling-element circulation path, wherein the lubricating path piece has formed therein a lubricating groove that constitutes the lubricating path, the lubricating path piece is fit into a fitting groove formed in a cover member main body of the at least one of the cover members, when the lubricating path piece is not fit into the fitting groove of the cover member main body, the fitting groove of the cover member main body is used as the lubricating path, and when the lubricating path piece is fit into the fitting groove of the cover member main body, the lubricating path is narrowed.

The invention of claim 8 is a lubricant supplying method of a motion guide device having: a raceway member having a rolling-element rolling portion formed thereon; a moving block having a loaded rolling-element rolling portion formed thereon facing the rolling-element rolling portion and having a rolling-element return path extending approximately in parallel with the loaded rolling-element rolling portion; a pair of cover members provided at respective moving-directional ends of the moving block and each having a direction change path connecting the loaded rolling-element rolling portion and the rolling-element return path; and a plurality of rolling elements arranged in a rolling-element circulation path including the loaded rolling-element rolling portion, the rolling-element return path and the direction change path, the method comprising: supplying the rolling-element circulation path with a lubricant via a lubricating path provided on at least one of the cover members, for oil lubrication using a lubricating oil as the lubricant, narrowing the lubricating path, while for grease lubrication using a grease as the lubricant, making the lubricating path wider than the lubricating path used in the oil lubrication.

The invention of claim 9 is a motion guide device comprising: a raceway member having a rolling-element rolling portion formed thereon extending in a longitudinal direction; a moving block having a loaded rolling-element rolling portion formed thereon facing the rolling-element rolling portion and having a rolling-element return path extending approximately in parallel with the loaded rolling-element rolling portion; a cover member provided at a moving-directional end of the moving block and having a direction change path connecting the loaded rolling-element rolling portion and the rolling-element return path; a plurality of rolling elements arranged in a rolling-element circulation path including the loaded rolling-element rolling portion, the rolling-element return path and the direction change path; and the cover member or a lubricating member mounted in the cover member having formed therein a first lubricant supply groove for supplying the rolling-element circulation path with a lubricant, and the first lubricant supply groove having formed therein a second lubricant supply groove which has a cross section smaller than a cross section of the first lubricant supply groove.

The invention of claim 10 is characterized by, in the motion guide device of claim 9, further comprising a rib portion, provided at each side of the second lubricant supply groove, extending along the second lubricant supply groove and protruding from a bottom surface of the first lubricant supply groove.

The invention of claim 11 is characterized by, in the motion guide device of claim 9, the first lubricant supply groove having an attachment fit therein in such a manner that the attachment obstructs the first lubricant supply groove and does not obstruct the second lubricant supply groove.

The invention of claim 12 is characterized in that, in the motion guide device of claim 11, the attachment is manufactured by stamping a sheet material.

The invention of claim 13 is characterized in that, in the motion guide device of claim 11, the attachment is made of an elastic material which is softer than the lubricating member or the cover member in which the attachment is fit.

The invention of claim 14 is characterized in that, in the motion guide device of claim 11, in using a grease as the lubricant, the attachment is not fit in the first lubricant supply groove, and in using a lubricating oil as the lubricant, the attachment is fit in the first lubricant supply groove.

The invention of claim 15 is characterized in that, in the motion guide device of claim 9, the first lubricant supply groove and the second lubricant supply groove are formed in the cover member, and the lubricant supply path for supplying the rolling-element rolling path with the lubricant is formed between an end surface of the moving block in contact with the cover member and the cover member in which the first lubricant supply groove and the second lubricant supply groove are formed.

The invention of claim 16 is characterized in that, in the motion guide device of claim 9, the first lubricant supply groove and the second lubricant supply groove are formed in the lubricating member, and the lubricant supply path for supplying the rolling-element rolling path with the lubricant is formed between the cover member in contact with the lubricating member and the lubricating member in which the first lubricant supply groove and the second lubricant supply groove are formed.

The invention of claim 17 is a motion guide device comprising: a raceway member having a rolling-element rolling portion formed thereon extending in a longitudinal direction; a moving block having a loaded rolling-element rolling portion formed thereon facing the rolling-element rolling portion and having a rolling-element return path extending approximately in parallel with the loaded rolling-element rolling portion; a cover member provided at a moving-directional end of the moving block and having a direction change path connecting the loaded rolling-element rolling portion and the rolling-element return path; a plurality of rolling elements arranged in a rolling-element circulation path including the loaded rolling-element rolling portion, the rolling-element return path and the direction change path; and a lubricant supply path component which constitutes a lubricant supply path for supplying a lubricant to the rolling-element rolling circulation path, the lubricant supply path component having a first lubricant supply groove formed therein as the lubricant supply path and a second lubricant supply groove, further formed in the first lubricant supply groove, having a cross section smaller than a cross section of the first lubricant supply groove.

The invention of claim 18 is an attachment for a motion guide device having: a raceway member having a rolling-element rolling portion formed thereon extending in a longitudinal direction; a moving block having a loaded rolling-element rolling portion formed thereon facing the rolling-element rolling portion and having a rolling-element return path extending approximately in parallel with the loaded rolling-element rolling portion; a cover member provided at a moving-directional end of the moving block and having a direction change path connecting the loaded rolling-element rolling portion and the rolling-element return path; a plurality of rolling elements arranged in a rolling-element circulation path including the loaded rolling-element rolling portion, the rolling-element return path and the direction change path; a first lubricant supply groove, formed in the cover member or a lubricating member mounted in the cover member, for supplying the rolling-element circulation path with a lubricant; and a second lubricant supply groove, formed in the first lubricant supply groove, having a cross section smaller than a cross section of the first lubricant supply groove, wherein the attachment has a planar shape conforming to a planar shape of the first lubricant supply groove so as to fit the attachment into the first lubricant supply groove, and when the attachment is fit it the first lubricant supply groove, the attachment obstructs the first lubricant supply groove and does not obstruct the second lubricant supply groove.

The invention of claim 19 is a method for manufacturing a motion guide device having: a raceway member having a rolling-element rolling portion formed thereon extending in a longitudinal direction; a moving block having a loaded rolling-element rolling portion formed thereon facing the rolling-element rolling portion and having a rolling-element return path extending approximately in parallel with the loaded rolling-element rolling portion; a cover member provided at a moving-directional end of the moving block and having a direction change path connecting the loaded rolling-element rolling portion and the rolling-element return path; and a plurality of rolling elements arranged in a rolling-element circulation path including the loaded rolling-element rolling portion, the rolling-element return path and the direction change path, the method comprising: a cover member or lubricating member forming step of forming, in the cover member or a lubricating member mounted in the cover member, a first lubricant supply groove for supplying the rolling-element circulation path with a lubricant, and further forming, in the first lubricant supply groove, a second lubricant supply groove which has a cross section smaller than a cross section of the first lubricant supply groove; and a cover member or lubricating member fitting step of fitting the cover member or the lubricating member mounted in the cover member to the moving block.

The invention of claim 20 is a motion guide device comprising: a raceway member having a rolling-element rolling portion formed thereon; a moving block having a loaded rolling-element rolling portion formed thereon facing the rolling-element rolling portion and having a rolling-element return path extending approximately in parallel with the loaded rolling-element rolling portion; a pair of cover members provided at respective moving-directional ends of the moving block and each having a direction change path connecting the loaded rolling-element rolling portion and the rolling-element return path; a plurality of rolling elements arranged in a rolling-element circulation path including the loaded rolling-element rolling portion, the rolling-element return path and the direction change path; and a lubricating path, provided on at least one of the cover members, for supplying a lubricant to the rolling-element circulation path, wherein the at least one of the cover members has a lubricating path piece having formed therein a lubricating path groove which constitutes the lubricating path and a cover member main body having a fitting groove for fitting the lubricating path piece therein, the cover member main body is split into two or more split parts at a position for cutting the fitting groove, and the lubricating path piece fit into the fitting groove of the cover member main body is placed over a joint of the split parts of the cover member main body.

The invention of claim 21 is characterized in that, in the motion guide device of claim 20, the cover member main body is split into a pair of leg pieces facing respective side surfaces of the raceway member and having the direction change path provided thereon and a center piece facing an upper surface of the raceway member and placed between the leg pieces in pair.

The invention of claim 22 is characterized in that, in the motion guide device of claim 20, the cover member main body is split into a direction change path component that constitutes the direction change path and a base portion in which the direction change path component is mounted.

The invention of claim 23 is a method for manufacturing a motion guide device having: a raceway member having a rolling-element rolling portion formed thereon; a moving block having a loaded rolling-element rolling portion formed thereon facing the rolling-element rolling portion and having a rolling-element return path extending approximately in parallel with the loaded rolling-element rolling portion; a pair of cover members provided at respective moving-directional ends of the moving block and each having a direction change path connecting the loaded rolling-element rolling portion and the rolling-element return path; a plurality of rolling elements arranged in a rolling-element circulation path including the loaded rolling-element rolling portion, the rolling-element return path and the direction change path; and a lubricating path, provided on at least one of the cover members, for supplying a lubricant to the rolling-element circulation path, the method comprising: forming a lubricating path piece having a lubricating path groove which constitutes the lubricating path and a cover member main body having a fitting groove for fitting the lubricating path piece therein and being split into two or more split parts at a position for cutting the fitting groove; assembling the split parts of the cover member main body; and fitting the lubricating path piece into the fitting groove of the cover member main body in such a manner that the lubricating path piece is placed over a joint of the split parts of the cover member main body.

### EFFECTS OF THE INVENTION

According to the invention of claim 1, it is possible to change the lubricating path in accordance with the use environment of the motion guide device, for example, to widen the lubricating path for grease lubrication and to narrow the lubricating path for oil lubrication. Hence, it is possible to lubricate the rolling elements easily (with less pressure and small amount of lubricant) in either case.

According to the invention of claim 2, it is possible to adjust the width of the lubricating path by fitting the lubricating path piece into the cover member main body or not. Further, in heavily-used grease lubrication, it is possible to eliminate one of the pieces.

According to the invention of claim 3, it is possible to adjust the width of the lubricating path by fitting the oil lubricating piece into the cover member main body for oil lubrication and fitting the grease lubricating piece into the cover member main body for grease lubrication.

According to the invention of claim 4, the oil lubricating path groove and grease lubricating path groove are formed on the front and back surfaces of the lubricating path piece, and therefore, it is possible to address both of the oil lubrication and grease lubrication by turning the lubricating path piece upside down or not.

According to the invention of claim 5, as the circulation path is composed of two symmetrically-split lubricating path pieces of the same kind, it is possible to downsize the split lubricating path pieces. Hence, manufacturing of the split lubricating path pieces is facilitated.

According to the invention of claim 6, it is possible to adjust the width of the lubricating path by fitting the lubricating path piece into the cover member main body or not.

According to the invention of claim 7, it is possible to adjust the width of the lubricating path by fitting the lubricating path piece into the cover member main body or not.

According to the invention of claim 8, it is possible to change the lubricating path in accordance with the use environment of the motion guide device, for example, to widen the lubricating path for grease lubrication and to narrow the lubricating path for oil lubrication. Hence, it is possible to lubricate the rolling elements easily (with less pressure and small amount of lubricant) in either case.

According to the invention of claim 9, as the lubricant can flow in both the first lubricant supply groove and the second lubricant supply groove, the lubricant supply path is allowed to have a larger cross-sectional area. Meanwhile, if the attachment is fit into the first lubricant supply groove, the cross-sectional area of the lubricant supply path becomes equal to the cross-sectional area of the second lubricant supply groove only, so that the cross-sectional area of the lubricating path is downsized. Hence, the lubricant supply path becomes applicable to both of grease supply and lubricating oil supply.

According to the invention of claim 10, when the attachment is fit into the first lubricant supply groove, pressure applied to the attachment concentrates on a portion in contact with the rib portion. This makes it possible to enhance the hermeticity with use of the attachment. Besides, as the rib portion is provided, it is possible to prevent the attachment from being deformed to occlude the second lubricant supply groove.

According to the invention of claim 11, it is possible to enlarge or reduce the cross-sectional area of the lubricant supply path depending on the presence or absence of the attachment fit into the first lubricant supply groove. In addition, as the second lubricant supply groove is formed in the cover member or the lubricating piece by digging down the first lubricant supply groove, there is no need to form a groove in the surface of the attachment and the attachment is manufactured to have a plane surface. Accordingly, the attachment can be manufactured without resin molding and manufacture of the attachment is well facilitated.

According to the invention of claim 12, it is possible to manufacture the attachment easily. As the attachment is manufactured to have a plane surface and there is no need to form a groove in the surface of the attachment, manufacturing can be made by stamping.

According to the invention of claim 13, it is possible to enhance the hermeticity with use of the attachment

According to the invention of claim 14, the cross-sectional area of the lubricant supply path can be enlarged for grease supply and reduced for supply of lubricating oil.

According to the invention of claim 15, it is possible to form the lubricant supply path between the cover member and the end surface of the moving block.

According to the invention of claim 16, it is possible to form the lubricant supply path between the lubricating piece and the cover member.

According to the invention of claim 17, as the lubricant can flow in both the first lubricant supply groove and the second lubricant supply groove, the lubricant supply path is allowed to have a larger cross-sectional area. Meanwhile, if the attachment is fit into the first lubricant supply groove, the cross-sectional area of the lubricant supply path becomes equal to the cross-sectional area of the second lubricant supply groove only, so that the cross-sectional area of the lubricating path is downsized. Hence, the lubricant supply path becomes applicable to both of grease supply and lubricating oil supply.

According to the invention of claim 18, it is possible to enlarge or reduce the cross-sectional area of the lubricant supply path depending on the presence or absence of the attachment fit into the first lubricant supply groove.

According to the invention of claim 19, as the lubricant is made to flow in both of the first lubricant supply groove and the second lubricant supply groove, the lubricant supply path is allowed to have a larger cross-sectional area. Meanwhile, if the attachment is fit into the first lubricant supply groove, the cross-sectional area of the lubricant supply path becomes equal to the cross-sectional area of the second lubricant supply groove only, so that the cross-sectional area of the lubricating path is downsized. Hence, the lubricant supply path becomes applicable to both of grease supply and lubricating oil supply.

According to the invention of claim 20, though the cover member main body is split into pieces, there appears no joint of the cover member main body pieces. Hence, it is possible to prevent leakage of the lubricant. Therefore, the lubricant is sure to reach the rolling-element circulation path.

According to models of the motion guide device, there are a standard-type cover member and a wide-type cover member which have the same circulation structure and different width seen from the axial direction of the raceway member. If the cover member is split into two parts, that is, a center piece and a pair of leg pieces, as defined in the invention of claim 21, the paired leg pieces can be used commonly in the standard-type cover member and the wide-type cover member. This allows commonality of the die for leg pieces, thereby reducing the cost for die.

According to models of the motion guide device, the direction change path components which constitute the direction change path may be fit into the base portion of the cover member main body. According to the invention of claim 22, it is possible to prevent leakage of the lubricant from a gap between the base portion of the cover member main body and the direction change path components.

According to the invention of claim 23, though the cover member main body is split into pieces, there appears no joint of the cover member main body pieces. Hence, it is possible to prevent leakage of the lubricant. Therefore, the lubricant is sure to reach the rolling-element circulation path.

### BRIEF DESCRIPTION OF DRAWINGS

FIG. 1 is an exploded perspective view showing a linear guide according to a first embodiment of the invention;

FIG. 2 is a view showing a circulation structural portion of the linear guide;

FIG. 3 is a perspective view showing a lubricating path piece and an endplate main body;

FIG. 4 is a front view showing the endplate main body;

FIG. 5 is a front view of the endplate main body into which the lubricating path piece is fit;

FIG. 6 is a cross sectional view showing the lubricating path piece in contact with a moving block;

FIG. 7 is a front view of the endplate main body into which the oil lubricating piece is fit;

FIG. 8 is a front view of the endplate main body into which a grease lubricating piece is fit;

FIG. 9 is a cross sectional view showing the oil lubricating piece and grease lubricating piece in contact with the moving block;

FIG. 10 is a cross sectional view showing another example of the lubricating path piece;

FIG. 11 is a cross sectional view showing another example of the circulation path piece;

FIG. 12 is an exploded perspective view showing an endplate main body embedded in a motion guide device according to a second embodiment of the present invention;

FIG. 13 is a perspective view of lubricating path pieces (standard type and wide type);

FIG. 14 is a front view of the endplate main body with the lubricating path piece fit therein (standard type);

FIG. 15 is a front view of the endplate main body with the lubricating path piece fit therein (wide type);

FIG. 16 is a cross sectional view showing the lubricating path piece in contact with the moving block;

FIG. 17 is a view showing another example of the lubricating path piece and the endplate;

FIG. 18 is a cross sectional view of the lubricating path piece;

FIG. 19 is a cross sectional view of another example of the lubricating path piece;

FIG. 20 is a cross sectional view of another example of the lubricating path piece;

FIG. 21 is a perspective view of a motion guide device according to the third embodiment of the present invention (the view including a partial cross sectional view);

FIG. 22 is a cross sectional view of the motion guide device (cross sectional view taken in the direction perpendicular to the raceway rail);

FIG. 23 is a cross sectional view of a ball circulation path;

FIG. 24 is a front view of the endplate;

FIG. 25 is an enlarged view of the IIXV portion of FIG. 24;

FIG. 26 is a plane view of an attachment;

FIG. 27 is a plane view of an attachment;

FIG. 28 is a plane view of the endplate having the attachment embedded therein;

FIG. 29 is a perspective view of the endplate having the attachment embedded therein;

FIG. 30 is a cross sectional view of the endplate having the attachment embedded therein;

FIG. 31 is a cross sectional view taken along the line IIIXI-IIIXI of FIG. 25;

FIG. 32 shows a lubricant supply path for lubricating oil (side view of the moving block);

FIG. 33 shows a lubricant supply path for lubricating oil (plane view of the endplate);

FIG. 34 is a perspective view of a motion guide device according to a fourth embodiment of the present invention (the view including a partial cross sectional view);

FIG. 35 is a front view of the motion guide device (the view including a partial cross sectional view);

FIG. 36 is a plane view of the lubricating plate;

FIG. 37 is a cross sectional view taken along the line IIIXVII-IIIXVII of FIG. 36;

FIG. 38 is a plane view of the attachment;

FIG. 39 is a cross sectional view of the attachment embedded in the lubricating plate;

FIG. 40 shows a lubricant supply path for lubricating oil (side view of the moving block);

FIG. 41 is a perspective view showing a conventional lubricating method with use of a grease gun;

FIG. 42 is a perspective view showing a conventional forced supply method with use of an automatic pump;

FIG. 43 is a front view showing a conventional endplate; and

FIG. 44 is a perspective view showing a conventional example of an endplate and a separate member having a lubricating path groove formed therein.

### BRIEF DESCRIPTION OF REFERENCES

1 . . . raceway rail
1b . . . roller rolling surface (rolling-element rolling portion)
2 . . . moving block
2d . . . loaded roller rolling surface (loaded rolling-element rolling portion)
3 . . . roller (rolling element)
5 . . . endplate (cover member)
6 . . . direction change path
7 . . . loaded roller rolling path (loaded rolling-element rolling path)
8 . . . roller return path (rolling-element return path)
30 . . . inner-side direction change path component (direction change path component)
31 . . . split lubricating path piece
32 . . . endplate main body (cover member main body)
33 . . . lubricating path groove
35 . . . fitting groove
38 . . . lubricating path
39 . . . lubricating path piece
41 . . . oil lubricating piece
41a . . . oil lubricating path groove
42 . . . grease lubricating piece
42a . . . grease lubricating path groove
43, 44 . . . lubricating path
45 . . . lubricating path piece
46 . . . oil lubricating path groove
47 . . . grease lubricating path groove
51 . . . endplate main body
51a . . . center piece
51b . . . leg piece
51a-1 . . . wide type center piece
51a-2 . . . standard type center piece
51d . . . joint
52 . . . lubricating path piece
52-1 . . . standard type lubricating path piece
52-2 . . . wide type lubricating path piece
53 . . . fitting groove
55 . . . lubricating path groove
58 . . . lubricating path
59 . . . lubricating path piece
59a . . . lubricating path groove
71 . . . lubricating path piece
72 . . . base portion
73 . . . joint
101 . . . raceway rail (raceway member)
101a . . . ball rolling groove (rolling-element rolling portion)
103 . . . ball (rolling element)
104 . . . moving block
105 . . . moving block main body
105c . . . loaded ball rolling groove (loaded rolling-element rolling portion)
105d . . . ball return path (rolling-element return path)
106 . . . endplate (cover member, lubricant supply path component)
116 . . . direction change path
122 . . . first lubricant supply groove
123 . . . second lubricant supply groove
126, 129 . . . attachment
131 . . . bottom surface
132 . . . rib portion
141 . . . raceway rail (raceway member)
141b . . . roller rolling surface (rolling-element rolling portion)
142 . . . moving block
143 . . . roller (rolling element)
145 . . . moving block main body
145d . . . loaded roller rolling surface (loaded rolling-element rolling portion)
146 . . . endplate
147 . . . roller return path (rolling-element return path)
152 . . . lubricating plate (lubricating member, lubricant supply path component)
155 . . . first lubricant supply groove
155a . . . bottom surface
156 . . . second lubricant supply groove
157 . . . rib portion
158 . . . attachment

### BEST MODES FOR CARRYING OUT THE INVENTION

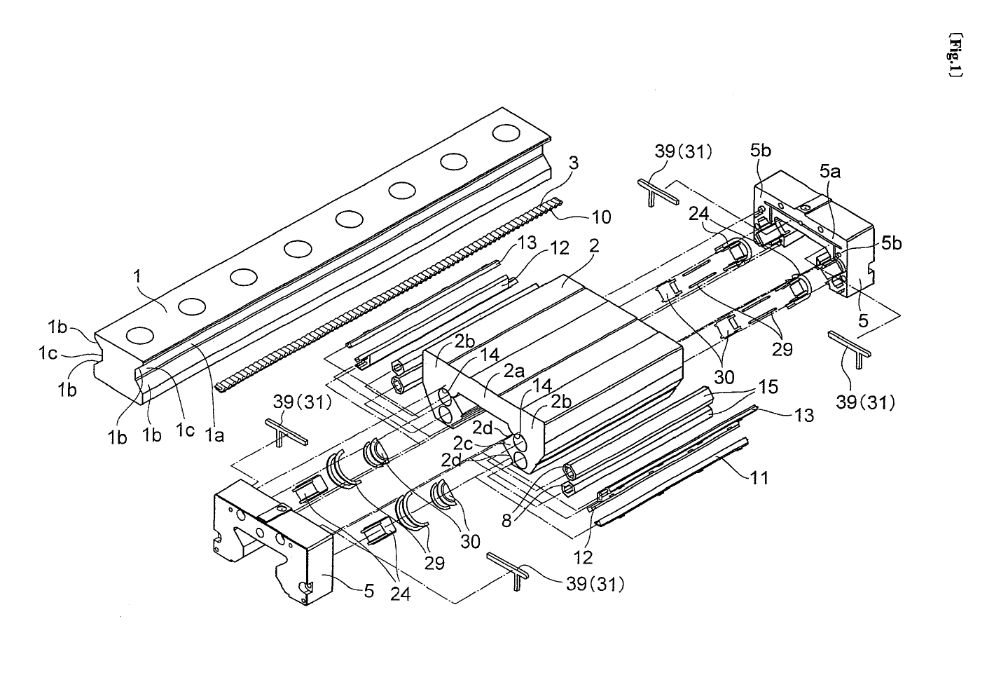

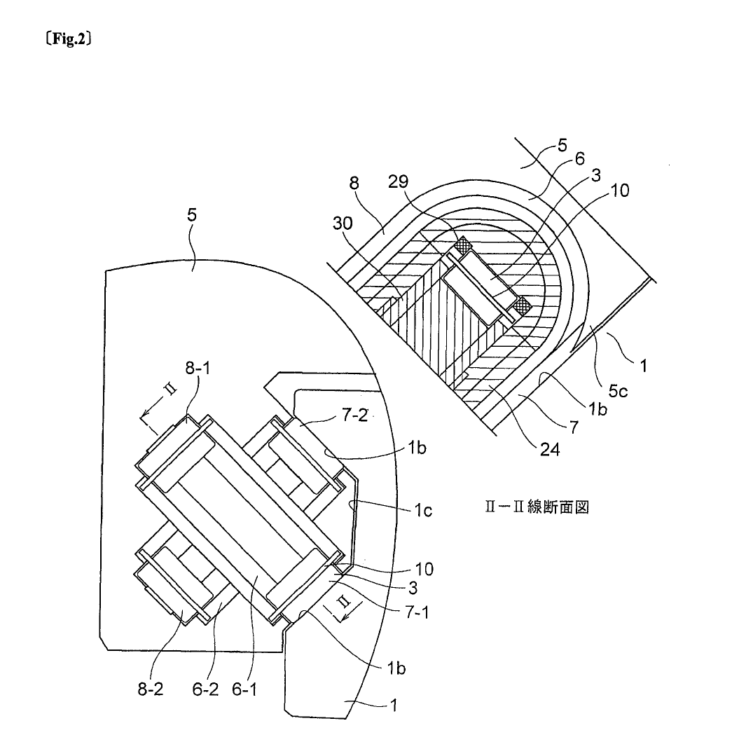

FIGS. 1 and 2 illustrate a linear guide as a motion guide device according to one embodiment of the present invention. FIG. 1 is an exploded perspective view of the linear guide, and FIG. 2 illustrates a circulation structure of the linear guide.

The linear guide has a raceway rail 1 extending straightly as a raceway member and a moving block 2 mounted movable on the raceway rail 1 via a large number of rollers 3 as rolling elements, and is for guiding linear movement of a moving body. In this embodiment, in order to realize high rigidity, rolling elements are rollers 3 which are resistant to elastic deformation, however, the rolling elements may be balls.

The raceway rail 1 elongates straightly and has a rectangular cross section. On both side surfaces of the raceway rail 1, grooves 1a are formed having wall surfaces 1b and bottom surfaces 1c along the longitudinal direction. Each of the upper wall surfaces 1b and the lower wall surfaces 1b is a roller rolling surface on which the rollers 3 roll. On each side surface of the raceway rail 1, there are two roller rolling surfaces 1b as rolling-element rolling portions, and totally four roller rolling surfaces for the raceway rail 1. As the rollers 3 roll on each of the roller rolling surfaces 1b, the roller rolling surfaces 1b are manufactured with cautions to the strength and surface roughness, and for example, the roller rolling surfaces 1b are subjected to grinding after hardening.

The moving block 2 has a center piece 2a opposed to an upper surface of the raceway rail 1 and side wall portions 2b opposed to the both side surfaces of the raceway rail 1 and extending down from the respective sides of the center piece 2a. On the side wall portions 2b of the moving block 2, there are formed protruding portions 2c shaped to match the shape of the groove 1a of the raceway rail 1. On these protruding portions 2c, loaded roller rolling surfaces 2d are formed as loaded rolling-element rolling portions corresponding to the respective roller rolling surfaces 1b. The loaded roller rolling surfaces 2d are provided two vertically arranged on each of the side wall portions 2b of the moving block 2, and totally, four loaded roller rolling surfaces 2d are formed for the moving block 2. As rollers 3 roll on these loaded roller rolling surfaces 2d, the loaded roller rolling surfaces 2d are also manufactured with cautions to the strength and surface roughness, and for example, the loaded roller rolling surfaces 2d are subjected to grinding after hardening.

Between the roller rolling surface 1b of the raceway rail 1, and the loaded roller rolling surface 2d of the moving block 2, there is arranged a plurality of rollers made of steel. The plural rollers 3 are held rotatably and slidably in chain by a holder 10.

On each of the side wall portions 2b of the moving block 2, through holes 14 are formed spaced by a given distance from the two vertically-arranged loaded roller rolling surfaces 2d and extending in parallel. In each through hole 14, a roller return path component 15 is inserted which constitutes a roller return path 8. The roller return path component 15 is made of a pair of pipe half bodies obtained by dividing the elongating pipe-shaped member into two along the axial direction. A roller return path 8 is formed on the inner surface of the roller return path component. The roller return path component 15 is inserted into the through hole 14 and then, fixed to the moving block 2 with both ends thereof supported by endplates 5.

Attached to the both edges of each loaded roller rolling surface 2d of the moving block 2 are long holding members 11, 12, 13 of resin. In the holding members 11, 12 and 13, a guide groove for guiding the holder 10 so that the rollers 3 can be prevented from dropping out from the loaded roller rolling surfaces 2d when the moving block 2 is removed from the raceway rail 1. A first holding member 11 guides the lower side of the holder 10 moving on the lower-side loaded roller rolling surface 2d. A second holding member 12 guides an upper side of the holder 10 moving on the lower-side the loaded roller rolling surface 2d and guides the lower side of the holder 10 moving on the upper-side loaded roller rolling surface 2d. A third holding member 13 guides the upper side of the holder 10 moving on the upper-side loaded roller rolling surface 2d.

There are provided, in each of the side wall portions 2b of the moving block 2, two loaded roller rolling paths 7-1 and 7-2 (see FIG. 2) each composed of a roller rolling surface 1b of the raceway rail 1 and a loaded roller rolling surface 2d of the moving block 2. Also there are provided, in each of the side wall portions 2b of the moving block 2, two roller return paths 8-1 and 8-2 (see FIG. 2) each composed of the roller return path component 15. In the endplates 5, direction change paths 6-1 and 6-2 are provided for these loaded roller rolling paths 7-1 and 7-2 and the roller return paths 8-1 and 8-2 crossings by building overpasses or underpasses.

An endplate 5 as a cover member is attached to each end surface in the moving direction of the moving block 2. The endplate 5 has a cross-sectional shape matching that of the moving block 2 and has a horizontal portion 5a and side wall portions 5b (see FIG. 1). As shown in FIG. 2, an outer-side direction change path 6-1 of the side wall portion 5b connects the lower loaded roller rolling path 7-1 and the upper roller return path 8-1. The inner-side direction change path 6-2 of the side wall portion 5b connects the upper loaded roller rolling path 7-2 and the lower roller return path 8-2. In other words, the outer-side direction change path 6-1 and the inner-side direction change path 6-2 connects the loaded roller rolling paths 7 and the roller return paths 8 by overhead crossing. As shown in FIG. 1, the outer-side direction change path 6-1 and the inner-side direction change path 6-2 are made up of endplate 5, inner-side/outer-side direction change path components 24 and the inner side direction change path component 30. The left-side view of FIG. 2 shows the inner-side and outer-side direction change path components 24 and the inner side direction change path component 30 removed from the endplate 5.

The inner-side/outer-side direction change path component 24 is approximately U-shaped as a whole. On the outer side of the inner-side/outer-side direction change path component 24, there is formed an inner side of the outer side direction change path 6-1, while on the inner side of the inner-side/outer-side direction change path component 24 there is formed an outer side of the inner side direction change path 6-2. Then, when the inner-side/outer-side direction change path component 24 is inserted into the endplate 5, the outer side of the inner-side/outer-side direction change path component 24 and the outer side of the outer-side direction change path 6-1 formed in the endplate 5 constitute the outer side direction change path 6-1. Besides, the outer side of the outer-side direction change path 6-2 formed in the endplate 5 is used to constitute the outer side of the inner side direction change path 6-2.

The inner-side direction change path component 30 is in the shape of a half cut of cylindrical column and has an inner-side of the inner-side direction change path formed on the outer surface thereof. After the inner-side/outer-side direction change path component 24 is fit in the endplate 5, this inner-side direction change path component 30 is fit in the endplate 5. Then, the endplate 5 and the inner-side direction change path component 30 constitute the inner-side direction change path 6-1.

Between the inner-side/outer-side direction change path component 24 and the inner-side direction change path component 30, there is a holder guiding member 29 fit therein. When the endplate 5 and the inner-side/outer-side direction change path component 24 make up the outer side of the inner-side direction change path, there occurs an elevation change at a joint of the endplate 5 and the inner-side/outer-side direction change path component 24. The holder guiding member 29 is provided to eliminate this elevation change formed on the outer side of the inner-side direction change path 6-2. The holder guiding member 29 is U-shaped as a whole and extends over the whole length of the outer side of the inner-side direction change path 6-2.

Next description is made about an assembling method of the linear guide. First, holding members 11, 12 and 13 and return path components 15 are assembled into the moving block 2. Then, inner-side/outer-side direction change path components 24, holder guiding members 29 and inner-side direction change path components 30 are fit into an endplate 5 sequentially, and the endplate 5 is attached to one end surface of the moving block 2. In this state, rollers 3 held in a row by each holder 10 are inserted into each of inner-side and outer-side circulation paths. Finally, the inner-side direction change path components 30, the holder guiding members 29, the inner-side/outer-side direction change path components 24 and the endplate 5 are sequentially attached to an opposite end surface of the moving block 2.

When the moving block 2 is moved relative to the raceway rail 1, the plural rollers 3 roll in each loaded roller rolling path between the loaded roller rolling surface 2d of the moving block 2 and the roller rolling surface 1b of the raceway rail 1. Once each roller 3 rolls up to one end of the loaded roller rolling surface 2d of the moving block 2, the roller 3 is scooped up by a scooping portion 5c formed on the endplate 5 as shown in FIG. 2, passes through the U-shaped direction change path 6 and finally enter the roller return path 8 extending in parallel with the loaded roller rolling path 7. After passing through the roller return path 8, the roller 3 rolls through the opposite-side direction change path and enters the loaded roller rolling path 7 again. The roller 3 circulates in a circular roller circulation path composed of the loaded roller rolling path 7, the direction change paths 6 and the roller return path 8. There are two circular circulation paths, that is, inner side one and outer side one, and rollers 3 circulate in each of the inner-side and outer-side circulation paths.

In use of such a rolling-type motion guide device, there is a need to form an oil film between rollers 3, roller rolling surfaces 1b and loaded roller rolling surfaces 2d thereby to prevent direct contact of metals. On this account, the endplate 5 is provided with a lubricating path for supplying lubricant to rollers 3. In this embodiment, as shown in FIG. 1, the lubricating path piece 39 which is a part of the lubricating path is provided as a separate element from the endplate 5 and fit in the endplate 5 detachably. In other words, as shown in FIG. 3, the endplate 5 includes the lubricating path piece 39 having the lubricating path groove 33 formed therein and the endplate main body 32 as the cover member main body having the fitting groove 35 formed therein.

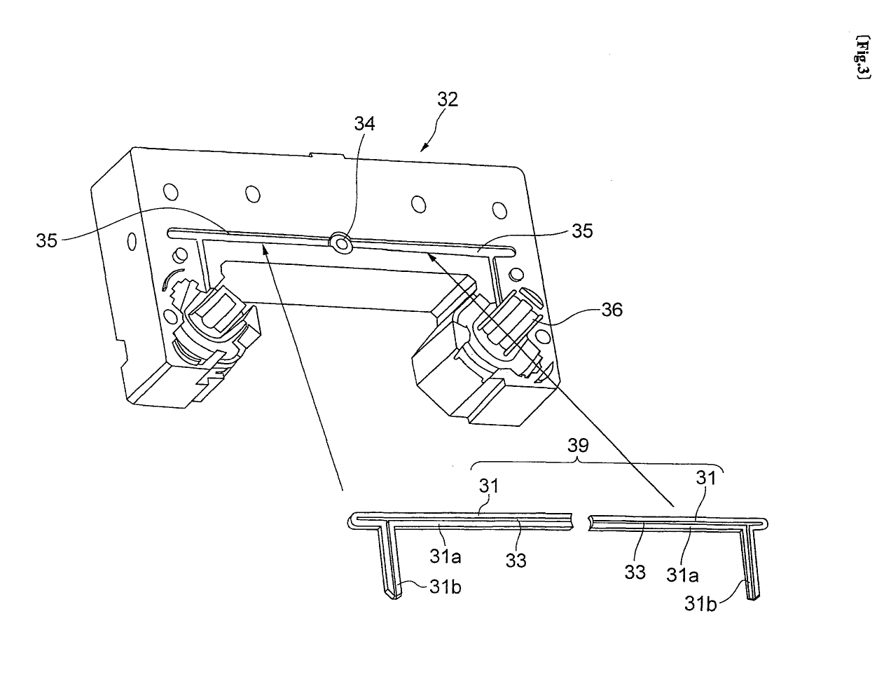

FIG. 4 is a front view of the endplate main body 32. At the center of the endplate main body 32, there is formed a lubricant supply hole 34 passing from the front surface of the endplate main body 32 to the back surface thereof. At the end of the back surface of the lubricant supply hole 34, a nipple is mounted for supplying lubricant with use of a grease gun or oil supply pump. If there is no space sufficient for the nipple attachment to the back surface of the endplate main body 32, there is formed a side surface lubricant supply hole 37 for attachment of nipple. This side surface lubricant supply hole 37 is linked to the fitting groove 35 formed on the front surface of the endplate main body 32.

In the front surface of the endplate main body 32, the fitting groove 35 is formed extending horizontally and being linked to the lubricant supply hole 34. The fitting groove 35 is formed horizontally symmetrical about the axial direction of the raceway rail 1, and finally, reaches the circulation structure 36 at their ends. More specifically, the fitting groove 35 has a horizontal groove 35a extending horizontally form the lubricant supply hole 34 and vertical grooves 35b bending downward from the respective ends of the horizontal groove 35a finally to reach the circulation structures 36.

As shown in FIG. 3, the lubricating path piece 39 is split into two horizontally symmetrically with respect to the axial direction of the raceway rail 1. As thus split, a split lubricating path piece 31 to be fit in the left-side fitting groove 35 is turned upside down to be able to be fit into the right-side fitting groove 35. Each split lubricating path piece 31 has a horizontal portion 31a conforming in shape to the horizontal groove 35a of the fitting groove 35 and a vertical portion 31b conforming in shape to the horizontal groove 35b. Besides, in each split lubricating path piece 31 a lubricating path groove 33 is formed in each of the front surface and back surface thereof.

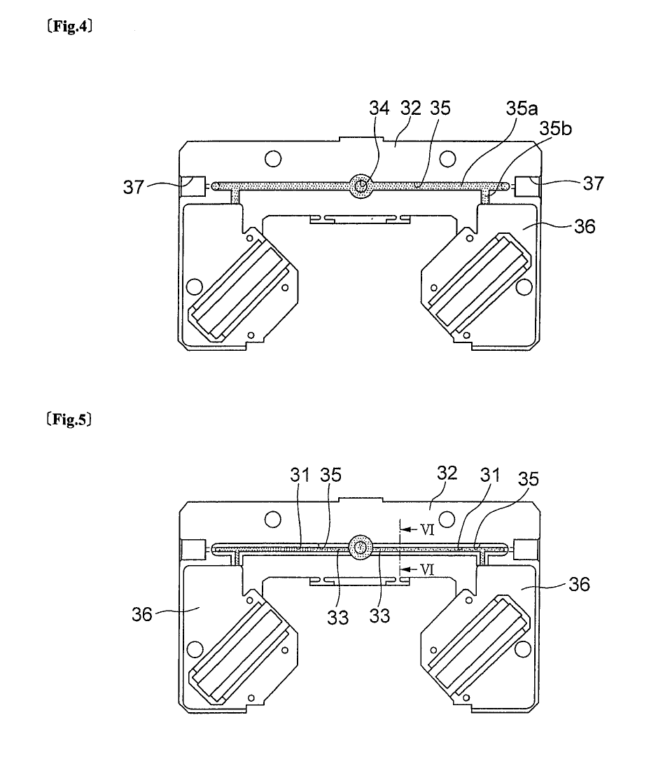

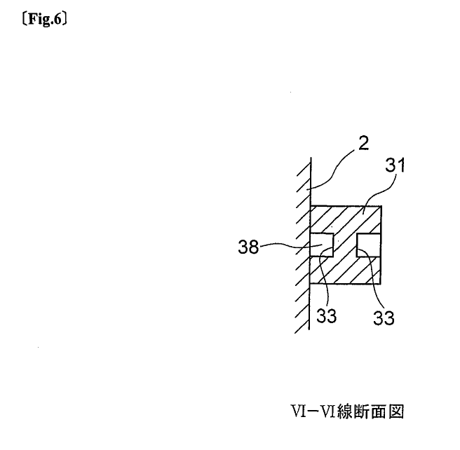

As shown in FIG. 6, when the split lubricating path piece 31 is brought into contact with the end surface of the moving block 2, a lubricating path 38 is formed between the moving block 2 and the lubricating path groove 33. The lubricating path groove 33 is formed in each of the front and back surfaces because the lubricating path 38 can be formed even if the split lubricating path piece 31 to be fit in the left-side fitting groove 35 is turned upside down to be fit into the right-side fitting groove 35. Here, in this embodiment, the lubricating path is formed of the moving block 2 and split lubricating path piece 31 which are in contact with each other, however, the lubricating path may be formed of the endplate main body 32 and split lubricating path piece 31 which are in contact with each other. Further, the width of the front-side lubricating path groove 33 may differ from the width of the back-side lubricating path groove 33. In this case, for grease lubrication, the two split lubricating path pieces 31 are fit into the symmetrical right and left sides, respectively, of the fitting groove 35 and the wider lubricating path groove 33 is brought into contact with the end surface of the moving block 2. On the other hand, for oil lubrication, the two split lubricating path pieces 31 are turned upside down to be fit into the right and left sides, respectively, of the fitting groove 35 and the narrower lubricating path groove 33 is brought into contact with the end surface of the moving block 2.

FIG. 5 is a front view of the endplate main body 32 having the split lubricating path pieces 31 fit therein. When the endplate main body 32 is attached to the end surface of the moving block 2, the split lubricating path pieces 31 are fixed as sandwiched between the moving block 2 and the endplate main body 32. Then, as described above, the split lubricating path pieces 31 are brought into contact with the end surface of the moving block 2 thereby to form the lubricating path 38 between the end surface of the moving block 2 and the lubricating path groove 33 of the split lubricating path pieces 31. When lubricant is injected form the nipple, the lubricant passes through the lubricant supply hole 34 of the endplate main body 32 and the lubricating path 38 of the lubricating path piece 39 to reach the circulation structure 36. In the circulation structure 36, as rollers 3 changes their moving directions, the rollers 3 are coated with the lubricant. The rollers 3 coated with the lubricant roll on the loaded roller rolling surface 2d of the moving block and the roller rolling surface 1b of the raceway rail 1, and these surfaces are also coated with the lubricant.

If the split lubricating path pieces 31 are not fit into the fitting groove 35 of the endplate main body 32, when the endplate main body 32 is attached to the moving block 2, the endplate main body 32 is in contact with end surface of the moving block 2 thereby to constitute a lubricating path (fitting groove 35) made of the moving block 2 and the endplate main body 32. When the lubricant is injected from the nipple, the lubricant passes through the lubricant supply hole 34 of the endplate main body 32 and the lubricating path between the fitting groove 35 of the endplate main body 32 and the end surface of the moving block 2 to reach the circulation structure 36.

The lubricant of a motion guide device includes grease (lithium grease, urea grease and the like) and lubricating oil (sliding surface oil, turbine oil, ISOVG32-68). As these have mutually contradictory properties, the cross-sectional area of the lubricant supply path is preferably made wider for use of grease as lubricant and narrower for use of lubricating oil as lubricant. In the case of grease lubrication using grease as lubricant, the split lubricating path pieces 31 are not fit in the fitting grove 35 of the endplate main body 32 and the fitting groove 35 of the endplate main body 32 is used as a lubricating path. Meanwhile, in the case of oil lubrication using lubricating oil as lubricant, the split lubricating path pieces 31 are fit in the fitting grove 35 of the endplate main body 32 to narrow the lubricating path. This enables lubrication of the circulation structure 36 even in any case and easily (with low pressure and a small amount of lubricant supply).

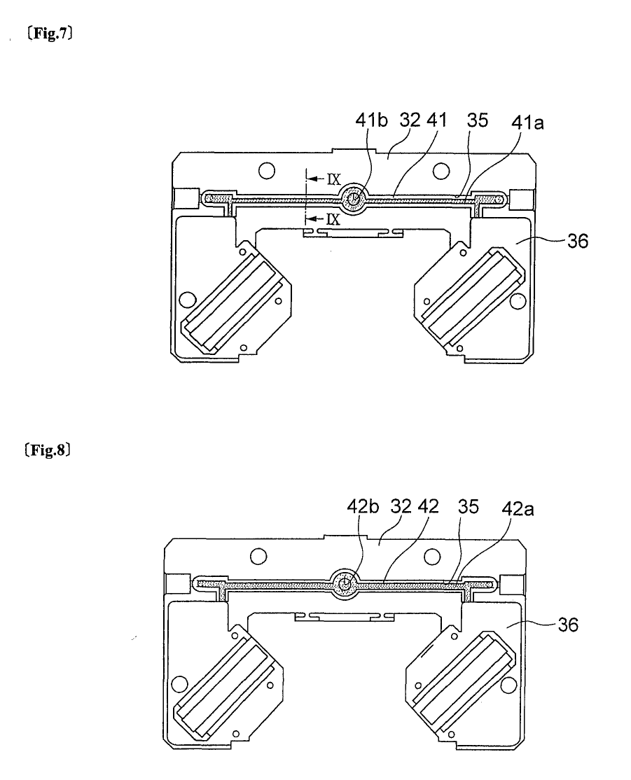

The method for narrowing the lubricating path for oil lubrication and widening the lubricating path for grease lubrication is carried out in various manners other than by fitting the lubricating path piece 39 or not. FIGS. 7 to 9 illustrate another example of the lubricating path piece 39. FIGS. 7 to 8 illustrate an endplate main body 32 having lubricating pieces 41, 42 fit therein. Each of the lubricating pieces 41 and 42 conform in shape to the fitting groove 35 and is fit in the fitting groove 35 with no space therebetween. Then, as the lubricating path pieces 41 and 42 there are two types, that is an oil lubricating piece 41 having a narrow oil lubricating path groove 41a formed therein as shown in FIG. 7 and a grease lubricating piece 42 having a grease lubricating path groove 42a which is wider than the oil lubricating path groove 41a.

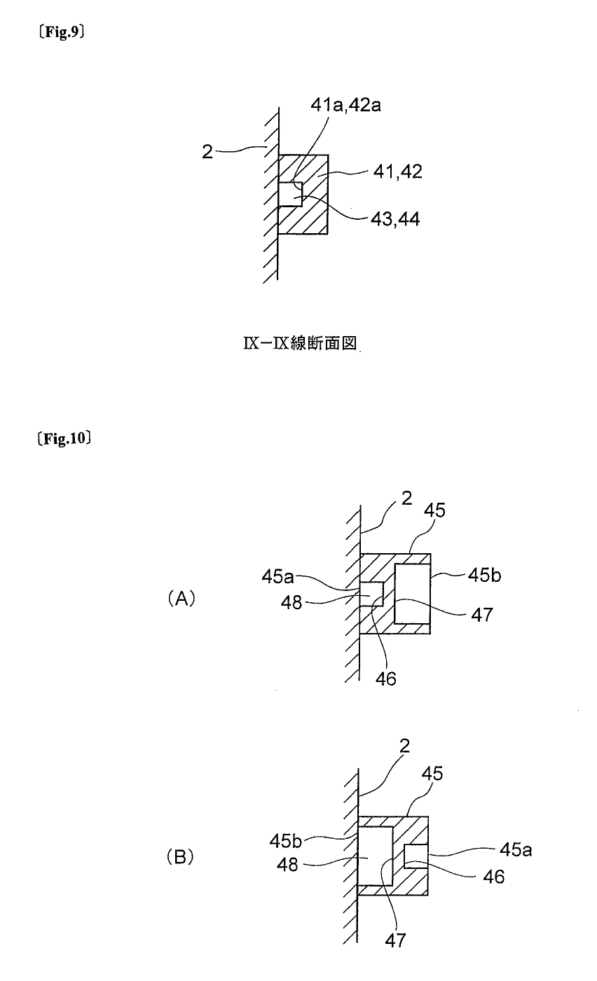

As shown in FIG. 7, the oil lubricating piece 41 elongates horizontally in conformity to the shape of the fitting groove 35 of the endplate main body 32. To the front side of the oil lubricating piece 41, the oil lubricating path groove 41a is formed elongating horizontally. At the center of the oil lubricating piece 41, there is formed a connecting hole 41b connecting to the lubricant supply hole 34 (see FIG. 4) of the endplate main body 32. This connecting hole 41b is also connected to the oil lubricating path groove 41a. When the endplate main body 32 having the oil lubricating piece 41 fit therein is attached to the end surface of the moving block 2, the oil lubricating piece 41 is sandwiched between the moving block 2 and the endplate main body 32 to be fixed thereto. Then, as shown in FIG. 9, the oil lubricating piece 41 is brought into contact with the end surface of the moving block 2 and a lubricating path 43 is formed between the end surface of the moving block 2 and the oil lubricating path groove 41a of the oil lubricating piece 41. When lubricating oil is injected from the nipple, the lubricating oil passes through the lubricant supply hole 34 of the endplate main body 32, the connecting hole 41b of the oil lubricating piece 41 and the oil lubricating path groove 41a of the oil lubricating piece 41 to each the circulation structure.

As shown in FIG. 8, the grease lubricating piece 42 elongates horizontally in conformity to the shape of the fitting groove 35 of the endplate main body 32. On the front side of the grease lubricating piece 42, the grease lubricating path groove 42a is formed elongating horizontally. This grease lubricating path groove 42a has a wider cross-sectional area (larger in width and depth) than that of the oil lubricating path groove 41a of the oil lubricating piece 41. At the center of the grease lubricating piece 42, a connecting hole 42b is formed connecting to the lubricant supply hole 34 (see FIG. 4) of the endplate main body 32. This connecting hole 42b is also linked to the grease lubricating path groove.

Like the oil lubricating piece 41, when the endplate main body 32 having the grease lubricating piece 42 fit therein is attached to the end surface of the moving block 2, the grease lubricating piece 42 is fixed sandwiched between the moving block 2 and the endplate main body 32. Then, as shown in FIG. 9, the grease lubricating piece 42 is brought into contact with the end surface of the moving block 2 thereby to form a lubricating path 44 between the end surface of the moving block 2 and the grease lubricating path groove 42a of the grease lubricating piece 42. When grease is injected from the nipple, the grease passes through the lubricant supply hole 34 of the endplate main body 32, the connecting hole 42b of the grease lubricating piece 42 and the grease lubricating path groove 42a of the grease lubricating piece 42 to reach the circulation structure 36.

FIG. 10 shows another example of the lubricating path pieces. A lubricating path piece 45 of this example has a narrower oil lubricating path groove 46 formed on the front surface 45a and a wider grease lubricating path groove 47 formed on the back surface 45b and being wider than the oil lubricating path groove 46. Then, for oil lubrication using lubricating oil as a lubricant, as shown in FIG. 10(A), the lubricating path piece 45 is fit to the endplate main body 32, the front surface 45a of the oil lubricating path groove 46 is brought into contact with the end surface of the moving block 2 and the oil lubricating path groove 46 of the lubricating path piece 45 is used as a lubricating path 48. On the other hand, for grease lubrication using grease as lubricant, as shown in FIG. 10(B), the lubricating path piece 45 is fit to the endplate main body 32, the back surface 45b of the oil lubricating path groove 46 is brought into contact with the end surface of the moving block 2 and the grease lubricating path groove 47 of the lubricating path piece 45 is used as the lubricating path 48.

As another example of the method of narrowing the lubricating path for oil lubrication and widening the lubricating path for grease lubrication, two types of fitting grooves 35, that is, a narrow cross section type fitting groove 35 and a wide cross section type fitting groove 35, may be provided to be directly used as the lubricating path.

FIG. 11 shows yet another example of the lubricating path piece. In case of the lubricating path piece 39 as shown in FIGS. 3 and 6, the lubricating path piece 39 is in contact with end surfaces of the moving block 2 and the lubricating path 38 is formed between the lubricating path piece 39 and the moving block 2. On the other hand, in this example, the lubricating path 38 is formed between the lubricating path piece 59 and the endplate main body 32 by bringing the lubricating path piece 59 into contact with the endplate main body 32. In the lubricating path piece 59, a lubricating path groove 59a is formed. In this way, the lubricating path 38 may be formed between the moving block 2 and the lubricating path piece 59 or may be formed between the endplate main body 32 and lubricating path piece 59.

FIGS. 12 to 16 illustrate an endplate of a motion guide device according to a second embodiment of the present invention. The components, such as the raceway rail 1 and the moving block 2, other than the endplate are the same as those in the motion guide device of the first embodiment shown in FIG. 1, and therefore explanation is made only about the endplate.

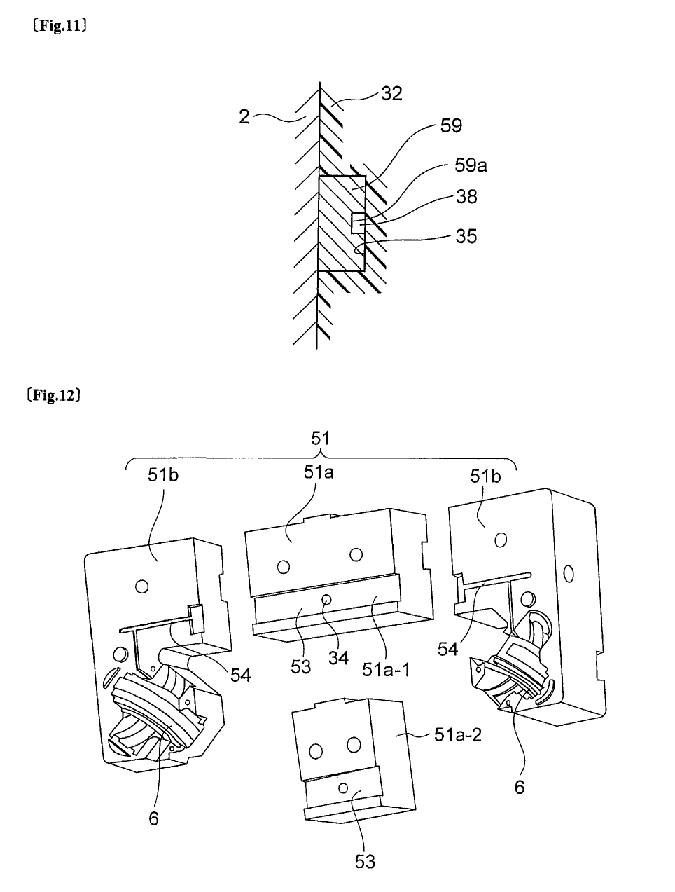

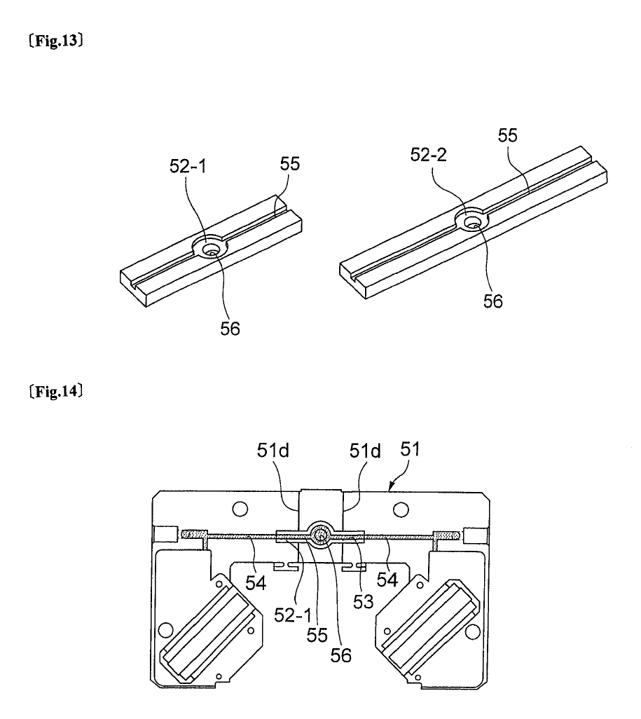

The endplate has a lubricating path piece 52 (see FIG. 13) having formed therein a lubricating path groove that constitutes a lubricating path and an endplate main body 51 having formed therein a fitting groove 53 in which the lubricating path piece is fit. As illustrated in FIG. 12, the endplate main body 51 is split into three parts, that is, a pair of leg pieces 51b that face the respective side surfaces of the raceway rail 1 and have a direction change path 6 formed therein, and a center piece 51a that faces the upper surface of the raceway rail 1 and is interposed between the paired leg pieces 51b. As the center piece 51a, two types are prepared such as a standard type center piece 51a-2 and a wide type center piece 51a-1 of which the width is larger than that of the standard type center piece 51a-2. When the standard type center piece 51a-2 is interposed between the paired leg pieces 51b, the endplate main body becomes a standard type one. When the wide type center piece 51a-1 is interposed between the paired leg pieces 51b, the endplate main body becomes a wide type one.

As the endplate main body, there are two types depending on model of the motion guide device, that is, standard type and wide type, that are different in width taken in the axial direction of the raceway rail 1, while the circulation structure of the endplate 51 is the same. As the endplate 5 is split into three, that is the paired leg pieces 51b facing the respective side surfaces of the raceway rail 1 and having the direction change path formed therein, and the center piece 51a facing the upper surface of the raceway rail 1 and being interposed between the paired leg pieces 51b, the paired leg pieces 51b are commonly used in both of the two, standard and wide type endplates 5. Accordingly, the die of the leg pieces 51b can be shared thereby reducing the cost of the die. As for the center pieces 51, the two, standard and wide type pieces are required to be prepared. However, as the center piece 51a does not have a circulation structure and has a simple shape, molding of the center piece with die is facilitated.

In the endplate main body 51, a fitting groove 53 is formed horizontally extending from the lubricant supply hole 34. At each end of the fitting groove 53, a lubricating path groove 54 is formed which has a narrower width and also extends horizontally. At a midpoint of the lubricating path groove 54, the groove extends downward to reach the direction change path 6. The endplate main body 51 is split into three at a position of cutting the fitting groove 53.

FIG. 13 is a perspective view of the lubricating path pieces 52 fit in the fitting groove of the endplate main body 51. The lubricating path piece 52 also has two types, a standard type piece 52-1 and a wide type piece 52-2 which is longer than the standard type 52-1. The plane shape of the lubricating path piece 52 is an approximately rectangular shape in conformity to the shape of the fitting groove 53. On the surface of the lubricating path piece 52, a lubricating path groove 55 is formed extending horizontally. At the center of the lubricating path piece 52, a connecting hole 56 is formed connecting to the lubricant supply hole 34 of the endplate main body 51. This connecting hole 56 is also connected to the lubricating path groove 55.

FIGS. 14 and 15 illustrate the endplate main body 51 having the lubricating path piece 52 fit therein. FIG. 14 illustrates the standard type endplate main body and FIG. 15 illustrates the wide type endplate main body. The lubricating path piece 52 fit in the fitting groove 53 goes over a joint 51d of the split parts of the endplate main body 51. When the lubricating path piece 52 is fit in the fitting groove 53, the connecting hole 56 of the lubricating path piece 52 is linked to the lubricant supply hole 34 of the endplate main body 51, while the lubricating path grooves 55 at both ends of the lubricating path piece 52 are linked to the lubricating path groove 54 of the endplate main body 51.

Next description is made about the method of manufacturing an endplate. First, the lubricating path piece 52 in which the lubricating path groove 55 is to be formed and the endplate main body pieces 51a and 51b which are split into two or more at the position of cutting the fitting groove 53 and in which the fitting groove 53 is to be formed for fitting the lubricating path piece 52 therein are prepared by injection molding. Next, the split endplate main body pieces 51a and 51b are bonded with bonding means such as adhesion, bolting or the like. Then, in the fitting groove 53 of the endplate main body pieces 51a and 51b, the lubricating path piece 52 is fit over the joint 51d of the split endplate main body pieces 51a and 51b. Finally, the endplate main body 51 is mounted on the end surface of the moving block 2.

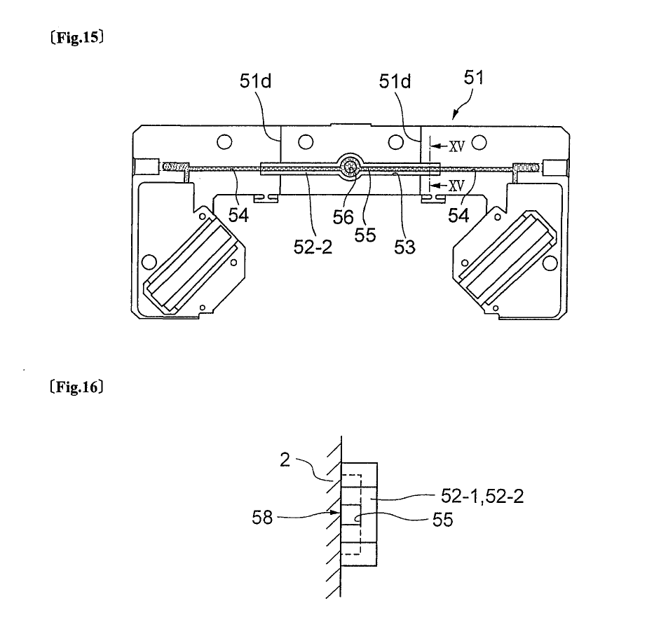

When the endplate main body 51 with the lubricating path piece 52 fit therein is attached to the end surface of the moving block 2, the lubricating path piece 52 is fixed as sandwiched between the endplate main body 51 and moving block 2. Then, as illustrated in FIG. 16, the lubricating path pieces 52-1 and 52-5 are brought into contact with the end surface of the moving block 2 and a lubricating path 58 is formed between the end surface of the moving block 2 and the lubricating path groove 55 of the lubricating path pieces 52-1 and 52-2. When a lubricant is injected via a nipple, the lubricant passes through the lubricant supply hole 34 of the endplate main body 51, the connecting hole 56 of the lubricating path pieces 52-1, 52-2, and the lubricating path groove 55 of the lubricating path pieces 52-1, 52-2 to reach the direction change path 6. As the lubricating path 58 is formed between the lubricating path groove 55 of the lubricating path pieces 52-1, 52-2 and the end surface of the moving block 2, if the endplate main body 51 is split, the joint portion 51d of the endplate main body 51 is not positioned in the lubricating path 58 and the lubricant is prevented from leaking from the joint portion 51d.

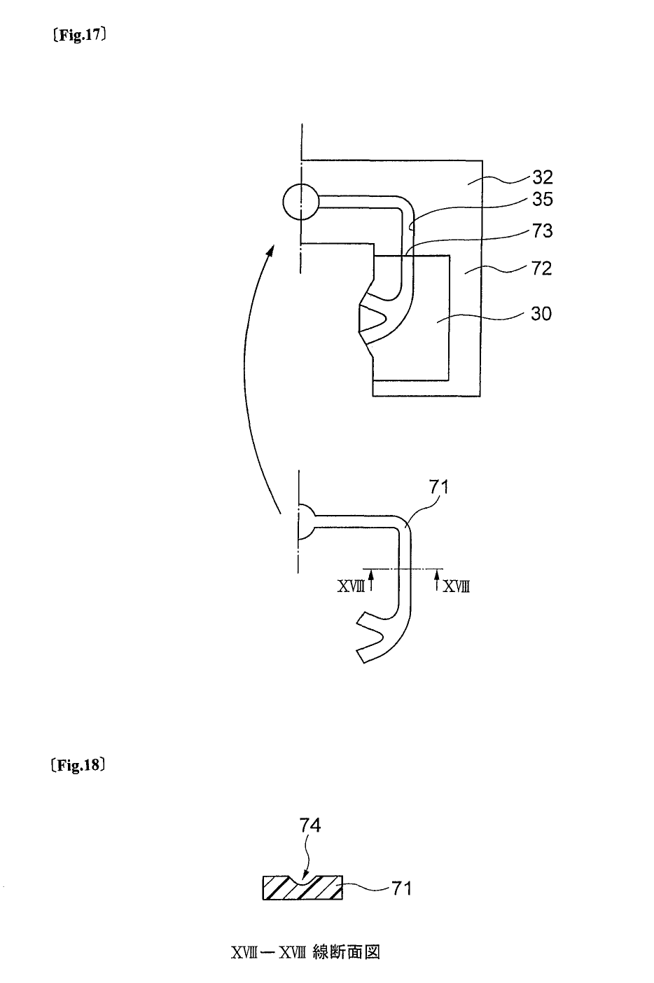

FIG. 17 illustrates another example of the lubricating path piece and endplate. In the motion guide device of the above-described first embodiment, as illustrated in FIG. 1, the endplate 5 has embedded therein the inner-side and outer side direction change path components 24 and the inner-side direction change path component 30 (hereinafter, referred to as a direction change path component 30) as direction change path components that constitute an overhead crossing direction change path. The upper side view of FIG. 17 is a front view of the endplate 5 having the direction change path component 30 fit therein. The endplate 5 is split into a base portion 72 and a direction change path component 30 fit in the base portion 72. With this structure, the fitting groove 35 of the endplate main body 32 is cut at a joint between the direction change path component 30 and the base portion 72, and there occurs a gap at the joint. In the fitting groove 35, a lubricating path piece 71 is fit in such a manner as to cover the joint 73. The thin-plate shaped lubricating path piece 71 is planar-shaped like the fitting groove 35.

As shown in the cross sectional view of FIG. 18, the lubricating path piece has a back surface formed into a plane and a lubricating path groove 74 is formed in a front surface. When the lubricating path piece 71 is fit in the fitting groove 35 of the endplate main body, there is formed a surface with no gap in the upper surface of the lubricating path piece 71. When a lubricating path groove 74 formed in the lubricating path piece 71 is used as a lubricating path, the joint is not formed the lubricating path and therefore, the lubricant can be prevented from leaking from the joint of the lubricating path.

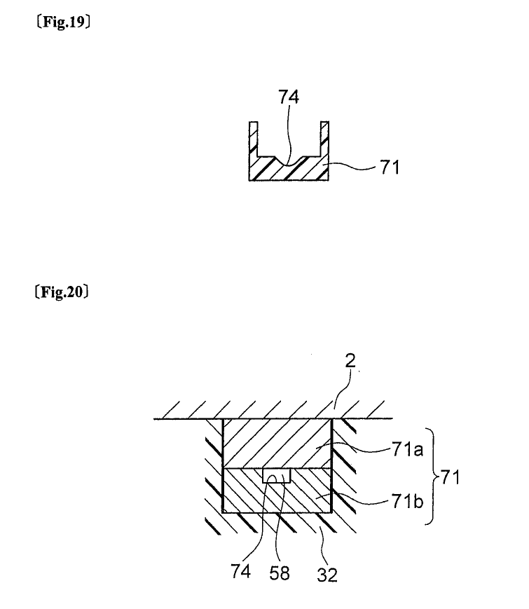

FIG. 19 illustrates another example of the lubricating path piece 71. As the cross-sectional shape of the lubricating path piece 71 is U shape composed of a bottom and side walls, not only the bottom surface of the fitting groove 35 but also the side surfaces serve as a bridge thereby preventing occurrence of a gap.

FIG. 20 illustrates another example of the lubricating path piece 71. In this example, two soft lubricating path pieces 71a, 71b are superposed to form a lubricating path therebetween. As the two soft lubricating path pieces 71a, 71b are superposed, sealing of the lubricating path can be enhanced. Here, if the lubricating path piece 71 is in contact with the end surface of the moving block 2, machining accuracy can be expected and therefore, sealing of the lubricating path can be improved by only one lubricating path piece. If the lubricating path piece 71 is in contact with a molded part, high machining accuracy can not be expected and therefore, the two lubricating path pieces 71a, 71b are preferably superposed as shown in this example.

The present invention is not limited to the above described embodiments and can be embodied in various forms without departing from the scope of the invention. Fog example, the lubricating path piece can constitute a lubricating path composed of a through hole inside the lubricating path piece by itself, though in the above-described embodiment the lubricating path is formed between the end surface of the moving block and the lubricating path groove of the lubricating path piece in contact therewith. In addition, the rolling elements may be balls in place with the rollers and the shape and structure of the raceway rail and moving block may be changed variously. Further, in the above-described embodiment, description treats the linear guide which has a moving block moving linearly, however, the present invention is also applicable to a curvilinear motion guide device for guising curvilinear motion. Furthermore, the present invention is also applicable to a spline including a ball spline and roller spline.

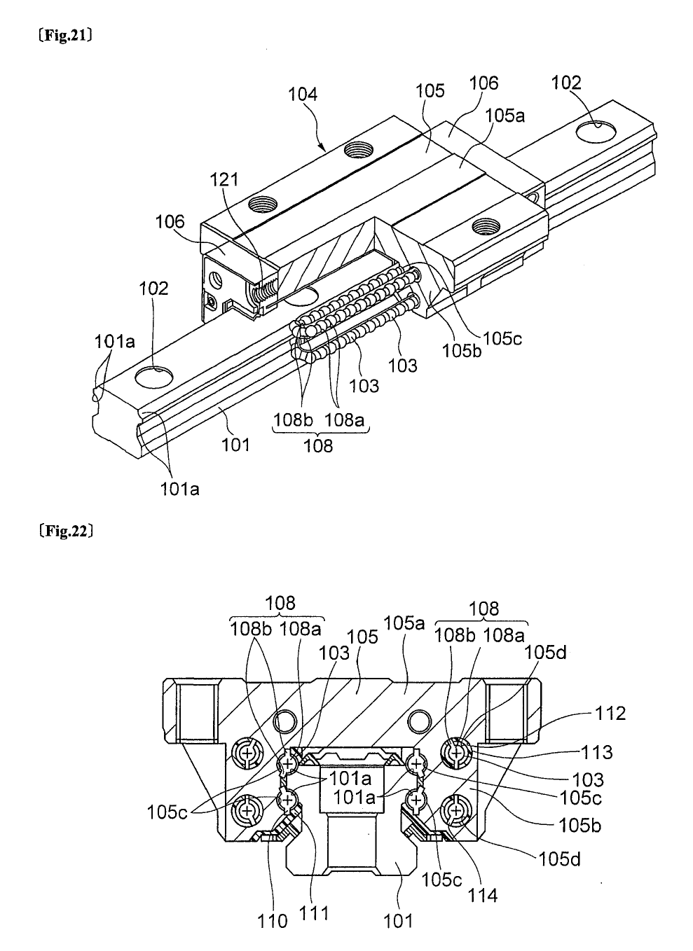

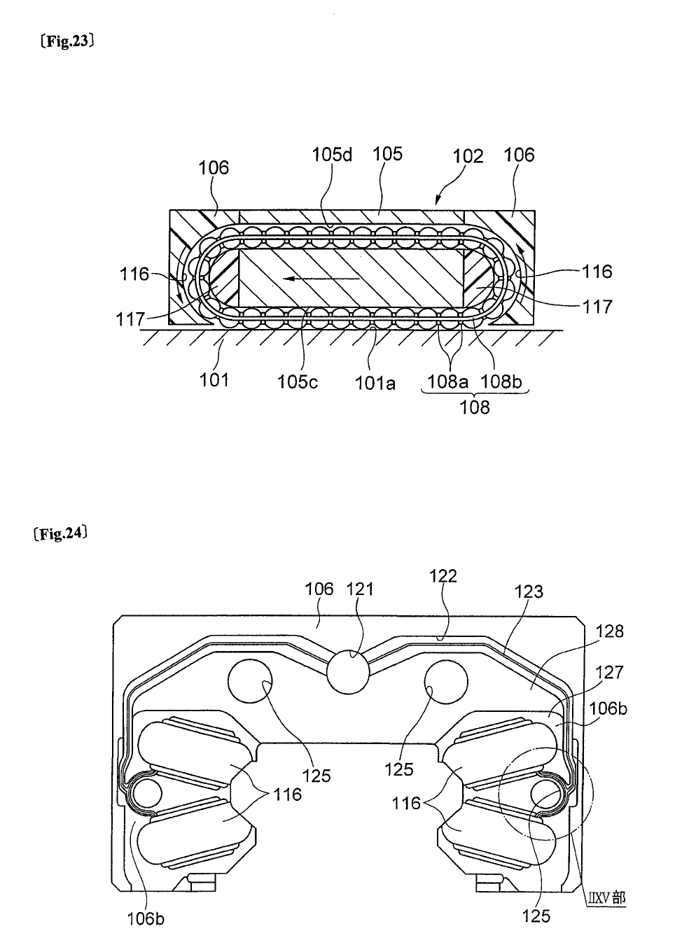

FIGS. 21 and 22 illustrate a motion guide device according to a third embodiment of the present invention. FIG. 21 is a perspective view of the motion guide device and FIG. 22 is a cross-sectional view of the motion guide device. FIG. 23 is a cross-sectional view of a ball circulation path of the motion guide device. The motion guide device of this embodiment is called linear guide and guides linear reciprocating motion of a moving body such as a table relative to a base. At a guide portion, a plurality of balls is placed as rolling elements.

On the base, a raceway rail 101 is mounted as a raceway member. In the raceway rail 101, mounting holes 102 are formed for fixing the raceway rail 101 to the base by connecting means such as bolts. The raceway rail 101 has a approximately-box-shaped cross section and elongates straightly. In each side surface of the raceway rail 101, for example, two ball rolling grooves 101a are formed extending along the longitudinal direction as rolling-element rolling portions. The cross-sectional shape of each ball rolling groove 101a is a circular arc groove shape composed of a single arc or a Gothic arch groove shape composed of two arcs. The number of ball rolling grooves 101a and a contact angle of the ball rolling groove and each ball are set to various values depending on load on the motion guide device. As each ball 103 rolls, the ball rolling groove 101a is manufactured having a small surface roughness and a large strength.

As shown in FIG. 22, the moving block 104 is mounted on the raceway rail 101 via the plural balls 103 movably relative to the raceway rail 101. The moving block 104 has a moving block main body 105 and a pair of endplates made of resin and provided at the respective moving-directional end of the moving block 104. The moving block main body 105 is saddle-shaped as a whole and has a center piece 105a facing the upper surface of the raceway rail 101 and side wall portions 105b extending downward from respective horizontal end of the center piece 105a and facing the respective side surface of the raceway rail 101. In each inner surface of the side wall portions 105b of the moving block main body, there are formed two vertically-spaced loaded ball rolling grooves 105c as loaded rolling-element rolling grooves facing the ball rolling grooves 101a of the raceway rail 101. As the plural balls 103 also roll on this loaded ball rolling grooves 105c, the loaded ball rolling grooves 105c are manufactured with small surface roughness and sufficient strength.

As illustrated in FIG. 21, the plural balls 103 on each bal circulation path are connected in series by a retainer band 108. Between adjacent two of balls 103, there is provided a cylindrical spacer 108a. Spacers 108a have their side surfaces connected by a pair of band-type connecting portions 108b. The paired connecting portion 108b and the plural spacers 108a are used to provide the retainer band 108 with pockets for holding the balls 103. As illustrated in FIG. 22, when seen from the moving direction of the balls 103, each connecting portion 108b protrudes from the balls 103. In each side of the loaded ball rolling groove 10c of the moving block 105, there is formed a guide groove 110 for guiding the connecting portions 108b protruding from the balls. The guide groove 110 is formed in a resin molded piece 111 which is integrally formed on the moving block main body. This guiding groove 110 is provided for preventing the balls 103 from dropping from the loaded ball rolling grooves 105c of the moving block 104 when the moving block 104 is removed from the raceway rail 101.

As shown in FIG. 22, in each side wall portion 105 of the moving block main body 105, there is provided a ball return path 105b as a rolling-element return path extending in parallel with the loaded ball rolling groove 105c. The number of ball return paths 105d provided is the same as that of the loaded ball rolling groove 105c. As the diameter of each ball return path 105d is larger than the diameter of each ball 103, the ball 103 does not bear load in the ball return path 105d. The ball 103 moves in the ball return path 105d while being pushed by a following ball 103 or drawn by an immediately preceding ball 103 via the retainer band 108. The ball return path 105d is formed by integrally molding a resin molded member 113 in a through hole 112 formed in the moving block main body 105. The ball return path 105d also has formed therein a guide groove 114 for guiding the connecting portion 108b of the retainer band 108.

On both ends in the moving direction of the moving block main body 105, an endplate 106 is mounted as a cover member. As shown in FIG. 23, the endplate 106 has a U-shaped direction change path 116 formed therein connecting the loaded ball rolling groove 105c and the ball return path 105d. More specifically, an outer-side part of the direction change path is formed in the endplate 106, and an inner side part, R piece portion, 11 is formed integrally on the end surface of the moving block main body 105 by injection molding. The endplate 106 and the R piece portion 117 are combined into the direction change path 116.

The loaded ball rolling groove 105c extending straightly, the ball return path 105d extending in parallel to the loaded ball rolling groove 105c and the U-shaped direction change path 116 connecting the loaded ball rolling groove 105c and the ball return path 105d constitute the circular ball circulation path. In this ball circulation path, a plurality of balls 103 is arranged held by a retainer band 108. When the moving block 104 moves relative to the raceway rail 101, the plural balls 103 roll on the loaded ball rolling path between the ball rolling groove 101a of the raceway rail 101 and the loaded ball rolling groove 105c of the moving block 104. Once rolling up to one end f the loaded ball rolling groove 105c of the moving block 104, each ball is scooped up by a scooping portion provided in the endplate 106 and then, passes through the U-shaped direction change path 116 to enter the ball return path 105d. After passing through the ball return path 105d, the ball passes through the opposite-side direction change path 116 and enters the loaded ball rolling path again. Totally, there are four circular ball circulation paths provided independently.

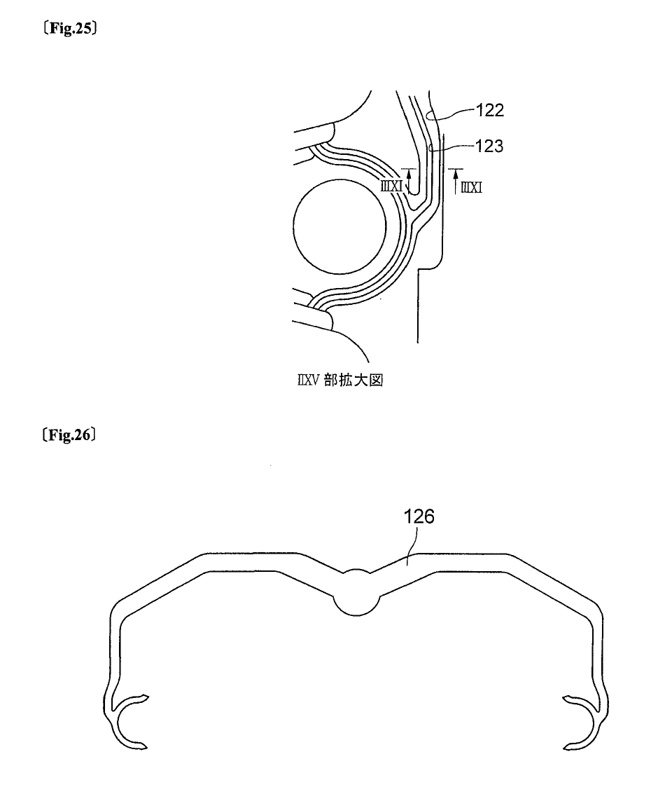

FIG. 24 is a plane view of the endplate 106 and FIG. 25 is an enlarged view of IIXV portion of FIG. 24. In the endplate 106, a through hole 121 is formed passing through the endplate 106 in the moving direction of the moving block 104. In the through hole 121, a screw thread is cut for mounting a nipple thereon (see FIG. 21). On an end surface of the endplate 106 in contact with the end surface of the moving block 105, a first lubricant supply groove 122 is formed. The first lubricant supply groove 122 is symmetrical about the center line of the endplate 106 and extends in horizontally both directions from the through hole 121. Then, the first lubricant supply groove 122 extends downward toward the direction change path 116 provided in each side wall portion 106b of the endplate 106 and is split at an intermediate portion of the vertically arranged two direction change paths to finally reach the two direction change paths 116. Between the end surface of the moving block main body 105 and the endplate 106 with the first lubricant supply groove 122 formed therein, a lubricant supply path is formed for supplying lubricant to the direction change path 116.

On the bottom surface of the first lubricant supply groove 122, there is formed the second lubricant supply groove 123 which has a cross-sectional area smaller than that of the first lubricant supply groove 122. Like the first lubricant supply groove 122, the second supply groove 123 is also symmetrical about the center line of the endplate 106 and extends in horizontally both directions from the through hole 121. Then, the second supply groove 123 extends downward toward the direction change path 116 provided in each side wall portion 106b of the endplate 106 and is split at an intermediate portion of the vertically arranged two direction change paths to reach the two direction change paths 116 at its ends. The path length of the second lubricant supply groove 123 is equal to the path length of the first lubricant supply groove 122.

In the endplate 106, there is formed a direction change path 116. The endplate 106 is manufactured by injection molding of resin conventionally as the shape of the endplate 106 is complicated. First and second lubricant supply grooves 122 and 123 are formed in the injection-molded endplate 106, they can be easily manufactured. The reference numeral 125 in the figure denotes a through hole for mounting the endplate 106 on the moving block main body 105.

FIG. 26 shows an attachment 126 fit in the first lubricant supply groove 122. The attachment 126 is an elastic member made of resin or rubber (preferably soft plastic) and softer than the endplate 106. This attachment 126 is manufactured by stamping a sheet material by pressing or cutting with a water jet cutter. The attachment 126 has the same plane shape as the first lubricant supply groove 122. The front surface and back surface of the attachments are both shaped into plane.

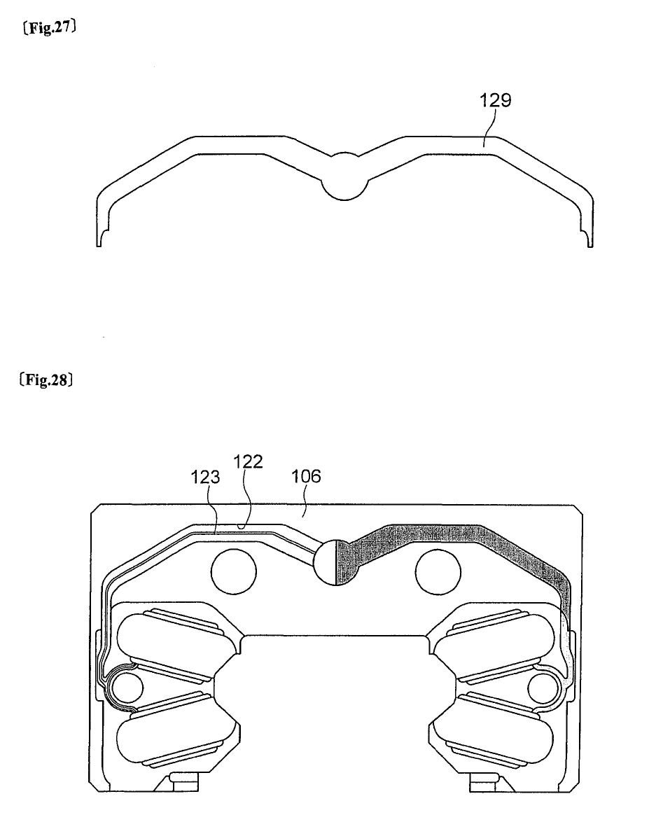

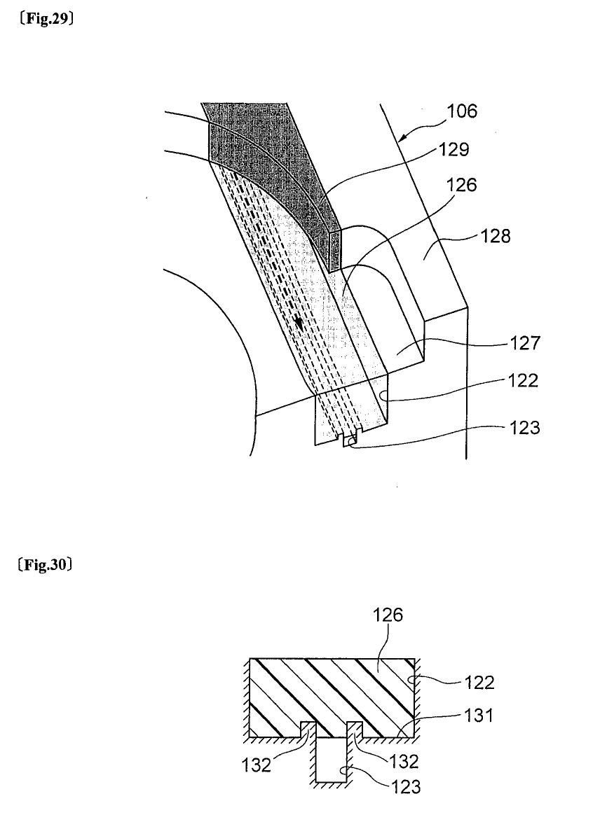

FIG. 27 illustrates an attachment 129 further fit in the first lubricant supply groove 122. As shown in FIG. 24, there is an elevation change in a portion 127 where the direction change path is formed on an end surface of the endplate 106 of this embodiment, and this portion is lower than another part 128 (see FIG. 29). In order to compensate this elevation change at the portion 127, the attachment 129 is provided. The planar shape of the attachment 129 is the same as the planar shape of the first lubricant supply groove 122 of the higher part 128 of the endplate 106. The front surface and back surface of the attachment 129 are both planar.

Here, if there is no elevation change on the end surface of the endplate 106, the attachment 129 can be eliminated. Besides, in this embodiment, two separately-provided attachments 126 and 129 are superposed to be used, however these two attachments 126 and 129 may be formed into one component.

FIGS. 28 and 29 show the first lubricant supply groove 122 of the endplate 106 in which the attachments 126 and 129 are fit removably. FIG. 28 show the attachment fit only in a right side of the first lubricant supply groove 122 of the endplate 106. Actually, the attachments 126 and 129 are fit into both of right side and left side of the first lubricant supply groove 122. When the attachment are fit in the first lubricant supply groove 122, the entire part of the cross section of the first lubricant supply groove 122 is covered. Meanwhile, if the attachments are fit in the first lubricant supply groove 122, the second lubricant supply groove 123 is not covered. The attachments 126 and 129 are sandwiched between the end surface of the moving block main body 105 and the bottom surface of the first lubricant supply groove 122. The attachments 126 and 129 have allowance (margin) and the thickness of the attachments 126 and 129 is larger than a gap between the end surface of the moving block main body 105 ad the bottom surface of the first lubricant supply groove 122. The attachment 126 and 129 made of elastic members are tightly fit to the bottom surface 131 of the first lubricant supply groove 122 (see FIG. 30) and the second lubricant supply groove 123 is tightly sealed.

As shown in FIGS. 29 and 30, at each side of the second lubricant supply groove 123, there may be provided two rib portions extending along the second lubricant supply groove 123. Each rib portion 132 jets from the bottom surface 131 of the first lubricant supply groove 122. This provision of the rib portion 132 allows deformation of the attachment 126 even if the attachment 126 is not given allowance. As a larger amount of deformation of the attachment 126 is allowed, the tight sealing of the second lubricant supply groove 123 can be further improved. Besides, if the rib portions 132 are not provided, the attachment 126 may be deformed thereby to fill in the second lubricant supply groove 123. As the rib portions 132 are provided, it is possible to prevent the attachment 126 from narrowing the second lubricant supply groove 123. Therefore, the second lubricant supply groove 123 having a fixed cross-sectional area is surely obtained.

As described above, the lubricant includes grease (lithium grease, urea grease and the like) and lubricating oil (sliding surface oil, turbine oil, ISOVG32-68). As these have mutually contradictory properties, the cross-sectional area of the lubricant supply path is made wider for use of grease as lubricant and narrower for use of lubricating oil as lubricant. A conventional endplate is provided with a lubricant supply path having a wide cross-sectional area for grease. If a lubricant supply path having a narrow cross-sectional area is provided, a tube is cut and provided on the outer side of the endplate or a lubricant supply apparatus having an oil tank is mounted on the end surface of the endplate. However, in this embodiment, both of the wide lubricant supply path for grease and the narrow lubricant supply path for lubricating oil are provided in the endplate 106.

In order to provide the wide lubricant supply path for grease, the first lubricant supply groove 122 is formed in the endplate 106. When the first lubricant supply groove 122 is used as lubricant supply path for grease, the attachment 126 is not fit in the first lubricant supply groove 122. As the second lubricant supply groove 123 is formed in the first lubricant supply groove 122, the second lubricant supply groove 123 is also used as the lubricant supply path for grease.

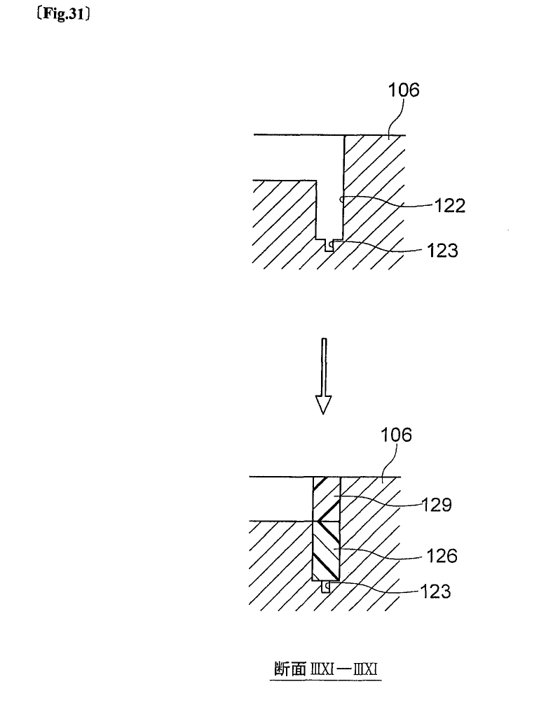

When the lubricating oil is used as lubricant, as shown in FIG. 31, the attachments 126 and 129 are fit in the first lubricant supply groove 122. When the first lubricant supply groove 122 is obstructed with the attachments 126 and 129, only the second lubricant supply groove 123 remains as the lubricant supply path. The lubricant supply path for lubricating oil is formed between the second lubricant supply groove 123 and the attachments 126 and 129. As the lubricating oil is supplied to the lubricant supply path by a pump with pressure, the lubricating oil is likely to leak therefrom. As the attachments 126 and 129 improves the tight sealing of the lubricant supply path, leakage of the lubricating oil from the lubricant supply path can be prevented.

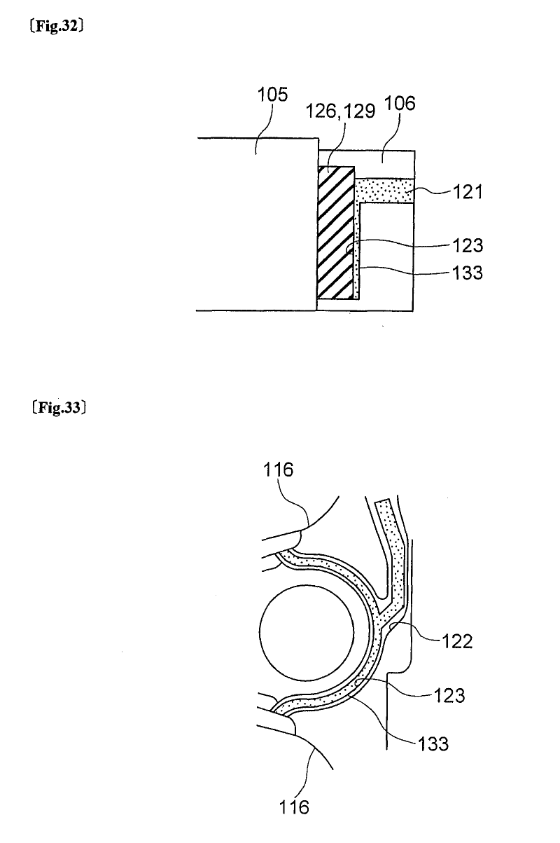

FIGS. 32 and 33 show the lubricant supply path for lubricating oil. The attachments 126 and 129 fit in the first lubricant supply groove 122 are interposed between the endplate 106 and the side surface of the moving block 105. The lubricating oil supplied from the nipple for lubricating oil supply of the endplate 106 passes through the through hole 121 of the endplate 106 and then through the lubricant supply path 133 formed between the second lubricant supply groove 123 and the attachments 126 and 129. Finally, the lubricating oil is discharged to the direction change path of the endplate 106.

Here, in stead of the second lubricant supply groove formed in the first lubricant supply groove 122, the second lubricant supply groove 123 may be formed in the attachment 126 so that the attachment 126 is fit into the first lubricant supply groove 122 thereby to narrow the cross-sectional area of the lubricant supply path for lubricating oil. However, this method needs forming of the second lubricant supply groove 123 in the attachment 126 and the end surface of the attachment 126 does not become planar. The second lubricant supply groove 123 of the attachment cannot be manufactured without resin molding or machining. The resin molding needs a die and machining of the groove needs one more step. The cost for the attachment 126 is inevitably increased in either way.

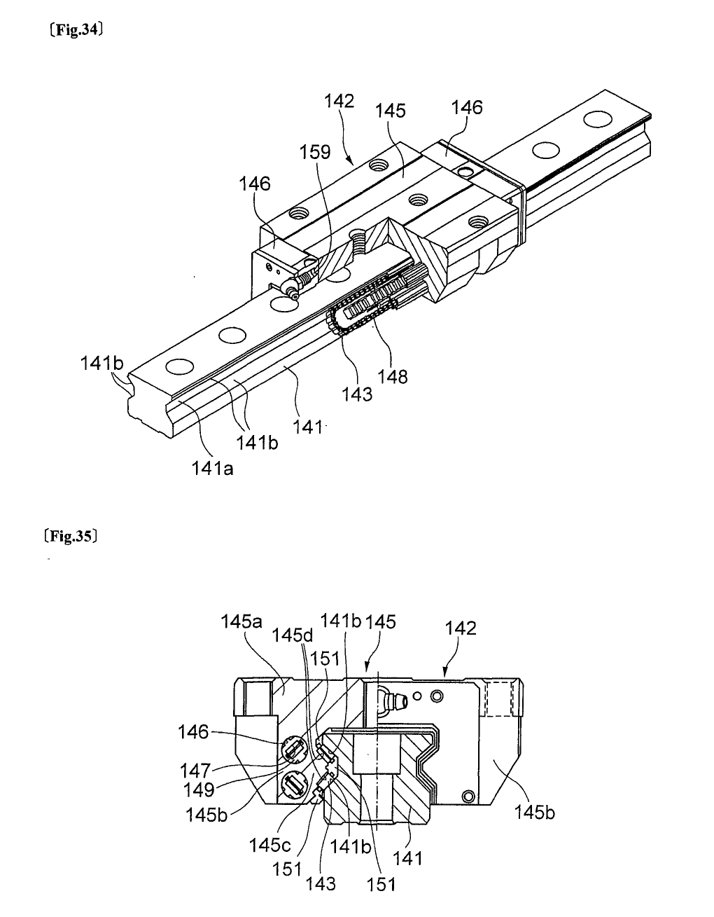

FIGS. 34 to 40 illustrate a motion guide device according to a fourth embodiment of the present invention. In the motion guide device of this embodiment, rollers are used instead of the balls as rolling elements. Besides, the first and second lubricant supply grooves formed in, instead of the endplate, a lubricating plate 152 as a lubricating member fit in the endplate.

FIGS. 34 and 35 are overall views of a motion guide device. FIG. 34 is a perspective view and FIG. 35 is a front view of the motion guide device. The motion guide device of this embodiment has a raceway rail 141 and a moving block 142 mounted on the raceway rail 141 movably relative to the raceway rail. Between the raceway rail 141 and the moving block 142, there are plural rollers arranged as rolling elements.

The raceway rail 141 elongates straightly and has an approximately box-shaped cross section. At each side surface of the raceway rail 141, a groove 141a is formed along the longitudinal direction. The upper side wall surface 141b and lower side wall surface 141b of the groove 141a are used as roller rolling surface for rolling of the rollers 143. Two roller rolling surfaces 141b are provided vertically-spaced in each side surface of the raceway rail 141 and totally four for the both side surfaces of the raceway rail 141.

The moving block 142 has a moving block main body 145, an endplate 146 attached to each moving-directional end of the moving block main body, and a lubricating plate 152 fit in the endplate 146. The moving block main body 145 has a centerpiece 145a facing the upper surface of the raceway rail 141 and side wall portions 145b opposed to the respective side surfaces of the raceway rail 141 and extends downward from both ends of the center piece 145a. In each of the side wall portions 145b of the moving block main body 145, there is formed a protruding portion which conforms in shape to the groove 141a provided in the side surface of the raceway rail 141. In this protruding portion 145c, loaded roller rolling surfaces 145d are formed as loaded rolling-element rolling portions corresponding to the roller rolling surfaces 141b. Totally four loaded roller rolling surfaces 145d are provided two for each side wall portion 145b of the moving block main body 145.

As illustrated in FIG. 34, a plurality of rollers 143 made of steel is arranged between the roller rolling surface 141b of the raceway rail 141 and the loaded roller rolling surface 145d of the moving block main body 145. The plural rollers 143 are held rollably, slidably and sequentially by a retainer band 148.

As illustrated in FIG. 35, on each of the side wall portions of the moving block main body 145, vertically-arrange two through holes 146 are formed extending in parallel to and spaced a predetermined distance away from the loaded roller rolling surfaces 145d. Inserted into each of these through holes 146 is a roller return path component 149 which constitutes a roller return path 147. The roller return path component 149 is in the shape of an elongating pipe. After the roller return path component 149 is inserted into the through hole 146, both ends of the roller return path component 149 are supported inside the endplate 146.

To each end of the loaded roller rolling surface 145d of the moving block main body, there is attached a long holding member 151 made of resin. In the holding member 151, a guide groove is formed for guiding the retainer band 148 so that the rollers 143 are prevented from dropping from the loaded roller rolling surface 145d when the moving block m142 is removed from the raceway rail 141.

There are provided in each side wall portion 145b of the moving block main body 145, two loaded roller rolling paths each composed of the roller rolling surface 141b of the raceway rail 141 and the loaded roller rolling surface 145d of the moving block main body 145. Also two roller return paths 147 are provided as arranged vertically in each side wall portion 145b of the moving block main body 145. In the endplate 146, a direction change path is provided for connecting the loaded roller rolling surface and the roller return path 147.

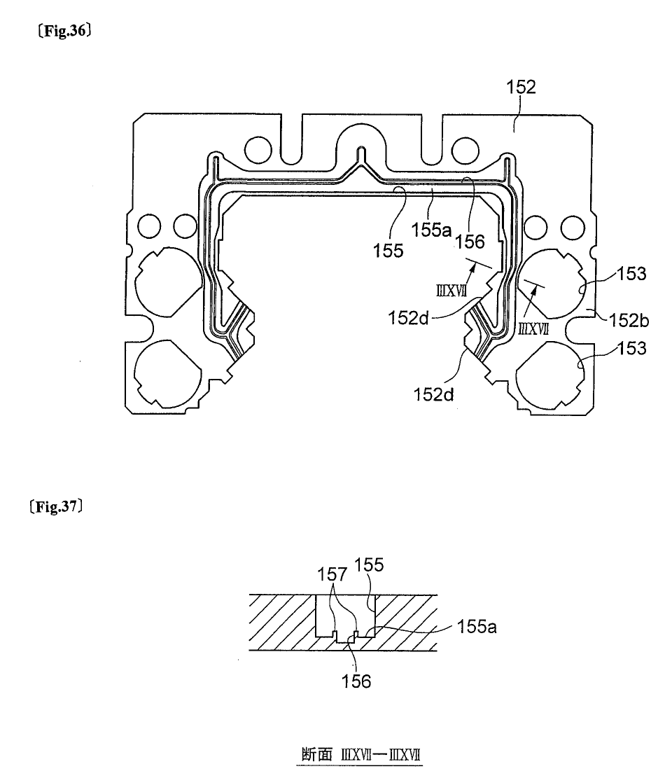

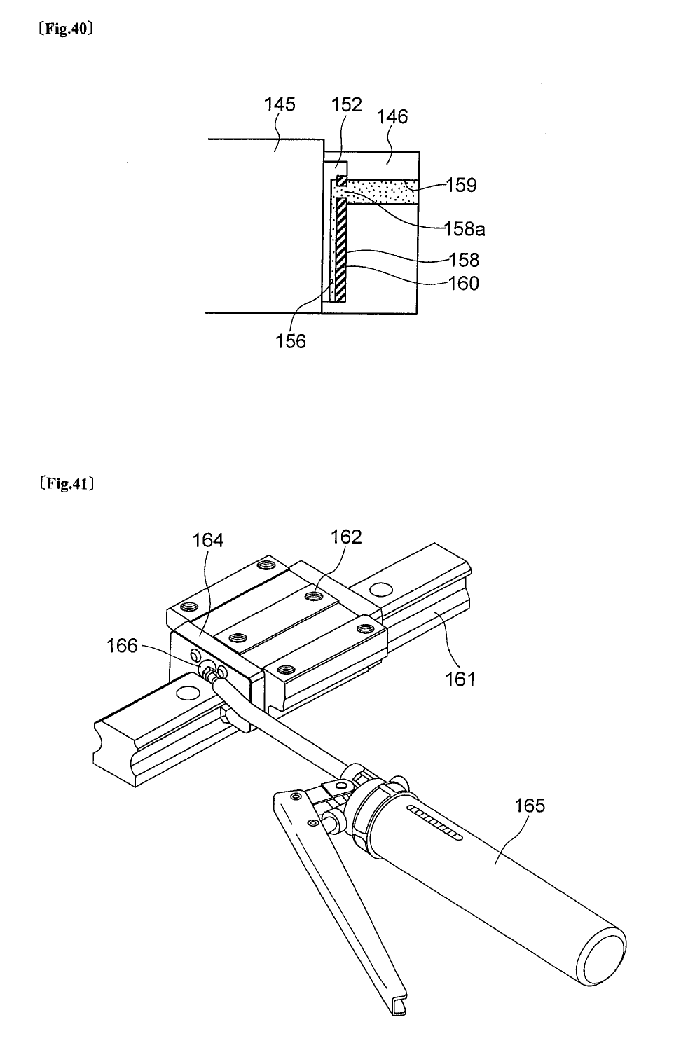

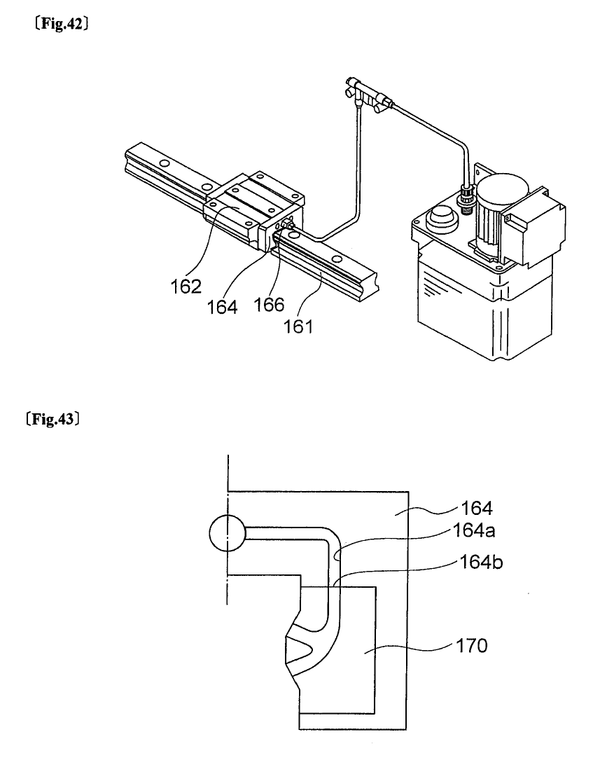

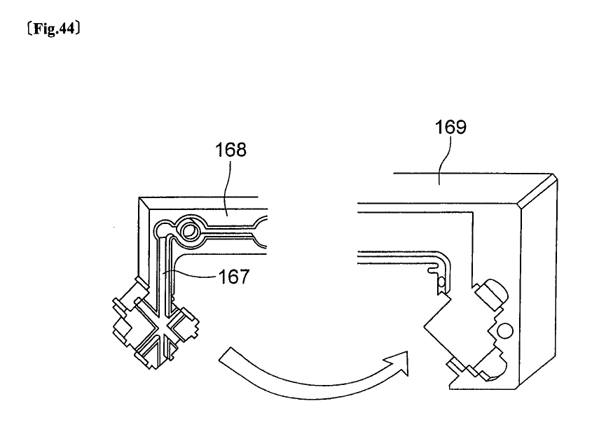

FIG. 36 illustrates a lubricating plate 152 fit in the endplate 146. The lubricating plate 152 is positioned between the endplate 146 and the end surface of the moving block 145 (see FIG. 40). The lubricating plate 152 is planar-shaped and slightly smaller than the endplate 146. The lubricating plate 152 is covered with the endplate 146. Each side wall portion 152b of the lubricating plate 152 has through holes formed therein for passage of the roller return path components 149.

In a surface of the lubricating plate 152 in contact with the endplate 146, there is formed a first lubricant supply groove 155. The first lubricant supply groove 155 is symmetrical about the center line of the lubricating plate 152 and extends in horizontally opposite directions from the center thereof. Then, the first lubricant supply groove 155 extends downward in each side wall portion 152b of the lubricating plate 152, split into two in the vicinity of the lubricating portion 152d that corresponds to the vertically-spaced two loaded roller rolling surfaces 145d and are linked to the vertically-spaced two lubricating portions 152d at its ends. In this example, between the lubricating plate 152 and the endplate 146, there is formed a lubricant supply path for supplying lubricant to the lubricating portion 152d.

In the bottom surface 155a of the first lubricant supply groove 155, a second lubricant supply groove 156 is formed having a smaller cross-sectional area than that of the first lubricant supply groove 155. The second lubricant supply groove 156 is also symmetrical about the center line of the endplate 146 and its ends are linked to two vertically-arranged lubricating portions 152d. The path length of the second lubricant supply groove 156 is equal to the path length of the first lubricant supply groove 155.

As illustrated in FIG. 37, at each side of the second lubricant supply groove 156, there is a rib portion 157 extending along the second lubricant supply groove 156 and jutting from the bottom surface 155a of the first lubricant supply groove 155. This rib portion 157 is used to shore up the edges of the second lubricant supply groove 156.

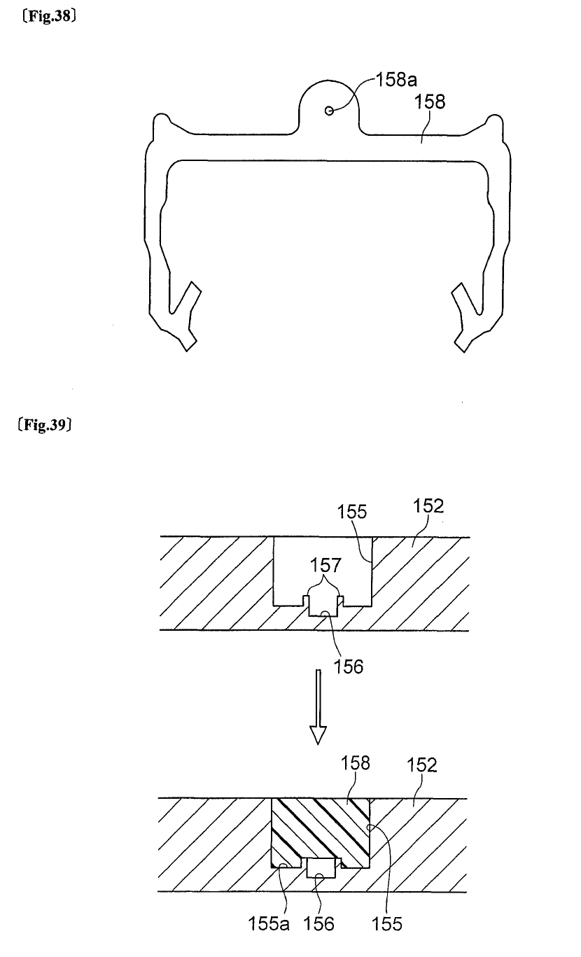

FIG. 38 shows the attachment 158 fit in the first lubricant supply groove 155. The planar shape of the attachment 158 is the same as that of the first lubricant supply groove 155. The front and back surfaces of the attachment 158 are both formed planar. In this embodiment, the attachment 158 has a through hole 158 formed therein for passage of the lubricating oil.

FIG. 39 shows the first lubricant supply groove 155 of the lubricating plate 152 having the attachment 158 fit therein. The attachment 158 is sandwiched between the end surface of the endplate 146 and the bottom surface 155a of the first lubricant supply groove 155 (see FIG. 40). When the attachment 158 is fit in the first lubricant supply groove 155, the first lubricant supply groove 155 is filled. On the other hand, the second lubricant supply groove 156 is not filled.

FIG. 40 illustrates a lubricant supply path for lubricating oil. The lubricating plate 152 is interposed between the end surface of the moving block main body 145 and the endplate 146. Between the lubricating plate 152 and the endplate 146, there is provided the attachment 158 fit in the first lubricant supply groove 155. The lubricating oil to be supplied from the nipple for lubricating oil supply of the endplate 146 passes from the through hole 159 of the endplate 146, passes through the through hole 158a of the attachment 158 and passes through the lubricant supply path 160 formed between the second lubricant supply groove 156 and the attachment 158. Then, the lubricating oil is discharged to a lubricating portion 152d of the lubricating plate 152.

Here, the present invention is not limited to the above-described embodiments, and can be embodied in various formed without departing from the scope of the present invention. In addition, the first and second lubricant supply grooves may be formed in a lubricant supply path component other than endplate and a lubrication plate (for example, a member attached to a moving block separate from the endplate or a member attached to the outside part of the endplate). Further, although the present invention is applied to the linear guide as a motion guide device in the above-described embodiment, the prevent invention can be applied to a curvilinear motion guide device for guiding curvilinear movement, a ball spline and a roller spline.

The present specification is based on Japanese Patent Application No. 2005-373459 filed on Dec. 26, 2005, Japanese Patent Application No. 2006-269537 filed on Sep. 29, 2006 and Japanese Patent Application No. 2006-269540 filed on Sep. 29, 2006, the entire contents of which are expressly incorporated by reference herein.

1. A motion guide device comprising:
a raceway member having a rolling-element rolling portion formed thereon;
a moving block having a loaded rolling-element rolling portion formed thereon facing the rolling-element rolling portion and having a rolling-element return path extending approximately in parallel with the loaded rolling-element rolling portion;
a pair of cover members provided at respective moving-directional ends of the moving block and each having a direction change path connecting the loaded rolling-element rolling portion and the rolling-element return path;
a plurality of rolling elements arranged in a rolling-element circulation path including the loaded rolling-element rolling portion, the rolling-element return path and the direction change path; and
a lubricating path, provided on at least one of the cover members, for supplying a lubricant to the rolling-element circulation path, the lubricating path being narrowed for oil lubrication using a lubricating oil as the lubricant and being widened for grease lubrication using a grease as the lubricant as compared with the oil lubrication.

2. The motion guide device according to claim 1, wherein the at least one of the cover members has a lubricating path piece having formed therein a lubricating path groove which constitutes the lubricating path and a cover member main body having a fitting groove for fitting the lubricating path piece therein,
for the oil lubrication using the lubricating oil as the lubricant, the lubricating path is narrowed by fitting the lubricating path piece into the fitting groove of the cover member main body, and
for the grease lubrication using the grease as the lubricant, the lubricating path piece is not fit to the fitting groove of the cover member main body to use the fitting groove of the cover member main body as the lubricating path.

3. The motion guide device according to claim 1, wherein the at least one of the cover members has a lubricating path piece having formed therein a lubricating path groove which constitutes the lubricating path and a cover member main body having a fitting groove for fitting the lubricating path piece therein,
the lubricating path piece includes an oil lubricating piece having a narrow oil lubricating path groove formed therein and a grease lubricating piece having formed therein a grease lubricating path groove that is wider than the oil lubricating path groove, and
for the oil lubrication using the lubricating oil as the lubricant, the oil lubricating piece is fit into the cover member main body, while for the grease lubrication using the grease as the lubricant, the grease lubricating piece is fit into the cover member main body.

4. The motion guide device according to claim 1, wherein the at least one of the cover members has a lubricating path piece having formed therein a lubricating path groove which constitutes the lubricating path and a cover member main body having a fitting groove for fitting the lubricating path piece therein,
the lubricating path groove has a narrow oil lubricating path groove formed on a front surface of the lubricating path piece and a grease lubricating path groove formed on a back surface of the lubricating path piece, the grease lubricating path groove being wider than the oil lubricating path groove,
for the oil lubrication using the lubricating oil as the lubricant, the lubricating path piece is fit into the cover member main body to use the oil lubricating path groove of the lubricating path piece as the lubricating path, and
for the grease lubrication using the grease as the lubricant, the lubricating path piece is fit into the cover member main body to use the grease lubricating path groove of the lubricating path piece as the lubricating path.

5. The motion guide device according to any one of claims 2 to 4, wherein the fitting groove of the cover member main body is formed horizontally symmetrical when seen in an axial direction of the raceway member,
the lubricating path piece is split into horizontally symmetrical two parts when seen in the axial direction of the raceway member, and
split lubricating path pieces of one kind having a substantially identical shape are fit into both right side and left side of the fitting groove.

6. A motion guide device comprising:
a raceway member having a rolling-element rolling portion formed thereon;
a moving block having a loaded rolling-element rolling portion formed thereon facing the rolling-element rolling portion and having a rolling-element return path extending approximately in parallel with the loaded rolling-element rolling portion;
a pair of cover members provided at respective moving-directional ends of the moving block and each having a direction change path connecting the loaded rolling-element rolling portion and the rolling-element return path;
a plurality of rolling elements arranged in a rolling-element circulation path including the loaded rolling-element rolling portion, the rolling-element return path and the direction change path; and
a lubricating path, provided on at least one of the cover members, for supplying a lubricant to the rolling-element circulation path, wherein
at least one of the cover members has a lubricating path piece having formed therein a lubricating path groove which constitutes the lubricating path and a cover member main body having a fitting groove formed therein for fitting the lubricating path piece therein,
when the lubricating path piece is not fit into the fitting groove of the cover member main body, the fitting groove of the cover member main body is used as the lubricating path, and
when the lubricating path piece is fit into the fitting groove of the cover member main body, the lubricating path is narrowed.

7. A lubricating path piece for a motion guide device having: a raceway member having a rolling-element rolling portion formed thereon; a moving block having a loaded rolling-element rolling portion formed thereon facing the rolling-element rolling portion and having a rolling-element return path extending approximately in parallel with the loaded rolling-element rolling portion; a pair of cover members provided at respective moving-directional ends of the moving block and each having a direction change path connecting the loaded rolling-element rolling portion and the rolling-element return path; a plurality of rolling elements arranged in a rolling-element circulation path including the loaded rolling-element rolling portion, the rolling-element return path and the direction change path; and a lubricating path, provided on at least one of the cover members, for supplying a lubricant to the rolling-element circulation path, wherein
the lubricating path piece has formed therein a lubricating groove that constitutes the lubricating path,
the lubricating path piece is fit into a fitting groove formed in a cover member main body of the at least one of the cover members,
when the lubricating path piece is not fit into the fitting groove of the cover member main body, the fitting groove of the cover member main body is used as the lubricating path, and
when the lubricating path piece is fit into the fitting groove of the cover member main body, the lubricating path is narrowed.

8. A lubricant supplying method of a motion guide device having: a raceway member having a rolling-element rolling portion formed thereon; a moving block having a loaded rolling-element rolling portion formed thereon facing the rolling-element rolling portion and having a rolling-element return path extending approximately in parallel with the loaded rolling-element rolling portion; a pair of cover members provided at respective moving-directional ends of the moving block and each having a direction change path connecting the loaded rolling-element rolling portion and the rolling-element return path; and a plurality of rolling elements arranged in a rolling-element circulation path including the loaded rolling-element rolling portion, the rolling-element return path and the direction change path, the method comprising:
supplying the rolling-element circulation path with a lubricant via a lubricating path provided on at least one of the cover members,
for oil lubrication using a lubricating oil as the lubricant, narrowing the lubricating path, while for grease lubrication using a grease as the lubricant, making the lubricating path wider than the lubricating path used in the oil lubrication.

9. A motion guide device comprising:
a raceway member having a rolling-element rolling portion formed thereon extending in a longitudinal direction;
a moving block having a loaded rolling-element rolling portion formed thereon facing the rolling-element rolling portion and having a rolling-element return path extending approximately in parallel with the loaded rolling-element rolling portion;
a cover member provided at a moving-directional end of the moving block and having a direction change path connecting the loaded rolling-element rolling portion and the rolling-element return path;
a plurality of rolling elements arranged in a rolling-element circulation path including the loaded rolling-element rolling portion, the rolling-element return path and the direction change path; and
the cover member or a lubricating member mounted in the cover member having formed therein a first lubricant supply groove for supplying the rolling-element circulation path with a lubricant, and the first lubricant supply groove having formed therein a second lubricant supply groove which has a cross section smaller than a cross section of the first lubricant supply groove.

10. The motion guide device according to claim 9, further comprising a rib portion, provided at each side of the second lubricant supply groove, extending along the second lubricant supply groove and protruding from a bottom surface of the first lubricant supply groove.

11. The motion guide device according to claim 9, the first lubricant supply groove having an attachment fit therein in such a manner that the attachment obstructs the first lubricant supply groove and does not obstruct the second lubricant supply groove.

12. The motion guide device according to claim 11, wherein the attachment is manufactured by stamping a sheet material.

13. The motion guide device according to claim 11, wherein the attachment is made of an elastic material which is softer than the lubricating member or the cover member in which the attachment is fit.

14. The motion guide device according to claim 11, wherein
in using a grease as the lubricant, the attachment is not fit in the first lubricant supply groove, and
in using a lubricating oil as the lubricant, the attachment is fit in the first lubricant supply groove.

15. The motion guide device according to claim 9, wherein the first lubricant supply groove and the second lubricant supply groove are formed in the cover member, and the lubricant supply path for supplying the rolling-element rolling path with the lubricant is formed between an end surface of the moving block in contact with the cover member and the cover member in which the first lubricant supply groove and the second lubricant supply groove are formed.

16. The motion guide device according to claim 9, wherein the first lubricant supply groove and the second lubricant supply groove are formed in the lubricating member, and the lubricant supply path for supplying the rolling-element rolling path with the lubricant is formed between the cover member in contact with the lubricating member and the lubricating member in which the first lubricant supply groove and the second lubricant supply groove are formed.

17. A motion guide device comprising:
a raceway member having a rolling-element rolling portion formed thereon extending in a longitudinal direction;
a moving block having a loaded rolling-element rolling portion formed thereon facing the rolling-element rolling portion and having a rolling-element return path extending approximately in parallel with the loaded rolling-element rolling portion;
a cover member provided at a moving-directional end of the moving block and having a direction change path connecting the loaded rolling-element rolling portion and the rolling-element return path;
a plurality of rolling elements arranged in a rolling-element circulation path including the loaded rolling-element rolling portion, the rolling-element return path and the direction change path; and
a lubricant supply path component which constitutes a lubricant supply path for supplying a lubricant to the rolling-element rolling circulation path, the lubricant supply path component having a first lubricant supply groove formed therein as the lubricant supply path and a second lubricant supply groove, further formed in the first lubricant supply groove, having a cross section smaller than a cross section of the first lubricant supply groove.

18. An attachment for a motion guide device having: a raceway member having a rolling-element rolling portion formed thereon extending in a longitudinal direction; a moving block having a loaded rolling-element rolling portion formed thereon facing the rolling-element rolling portion and having a rolling-element return path extending approximately in parallel with the loaded rolling-element rolling portion; a cover member provided at a moving-directional end of the moving block and having a direction change path connecting the loaded rolling-element rolling portion and the rolling-element return path; a plurality of rolling elements arranged in a rolling-element circulation path including the loaded rolling-element rolling portion, the rolling-element return path and the direction change path; a first lubricant supply groove, formed in the cover member or a lubricating member mounted in the cover member, for supplying the rolling-element circulation path with a lubricant; and a second lubricant supply groove, formed in the first lubricant supply groove, having a cross section smaller than a cross section of the first lubricant supply groove, wherein
the attachment has a planar shape conforming to a planar shape of the first lubricant supply groove so as to fit the attachment into the first lubricant supply groove, and
when the attachment is fit it the first lubricant supply groove, the attachment obstructs the first lubricant supply groove and does not obstruct the second lubricant supply groove.

19. A method for manufacturing a motion guide device having: a raceway member having a rolling-element rolling portion formed thereon extending in a longitudinal direction; a moving block having a loaded rolling-element rolling portion formed thereon facing the rolling-element rolling portion and having a rolling-element return path extending approximately in parallel with the loaded rolling-element rolling portion; a cover member provided at a moving-directional end of the moving block and having a direction change path connecting the loaded rolling-element rolling portion and the rolling-element return path; and a plurality of rolling elements arranged in a rolling-element circulation path including the loaded rolling-element rolling portion, the rolling-element return path and the direction change path, the method comprising:
a cover member or lubricating member forming step of forming, in the cover member or a lubricating member mounted in the cover member, a first lubricant supply groove for supplying the rolling-element circulation path with a lubricant, and further forming, in the first lubricant supply groove, a second lubricant supply groove which has a cross section smaller than a cross section of the first lubricant supply groove; and
a cover member or lubricating member fitting step of fitting the cover member or the lubricating member mounted in the cover member to the moving block.

20. A motion guide device comprising:
a raceway member having a rolling-element rolling portion formed thereon;
a moving block having a loaded rolling-element rolling portion formed thereon facing the rolling-element rolling portion and having a rolling-element return path extending approximately in parallel with the loaded rolling-element rolling portion;
a pair of cover members provided at respective moving-directional ends of the moving block and each having a direction change path connecting the loaded rolling-element rolling portion and the rolling-element return path;
a plurality of rolling elements arranged in a rolling-element circulation path including the loaded rolling-element rolling portion, the rolling-element return path and the direction change path; and
a lubricating path, provided on at least one of the cover members, for supplying a lubricant to the rolling-element circulation path,
wherein the at least one of the cover members has a lubricating path piece having formed therein a lubricating path groove which constitutes the lubricating path and a cover member main body having a fitting groove for fitting the lubricating path piece therein,
the cover member main body is split into two or more split parts at a position for cutting the fitting groove, and
the lubricating path piece fit into the fitting groove of the cover member main body is placed over a joint of the split parts of the cover member main body.

21. The motion guide device according to claim 20, wherein the cover member main body is split into a pair of leg pieces facing respective side surfaces of the raceway member and having the direction change path provided thereon and a center piece facing an upper surface of the raceway member and placed between the leg pieces in pair.

22. The motion guide device according to claim 20, wherein the cover member main body is split into a direction change path component that constitutes the direction change path and a base portion in which the direction change path component is mounted.

23. A method for manufacturing a motion guide device having: a raceway member having a rolling-element rolling portion formed thereon; a moving block having a loaded rolling-element rolling portion formed thereon facing the rolling-element rolling portion and having a rolling-element return path extending approximately in parallel with the loaded rolling-element rolling portion; a pair of cover members provided at respective moving-directional ends of the moving block and each having a direction change path connecting the loaded rolling-element rolling portion and the rolling-element return path; a plurality of rolling elements arranged in a rolling-element circulation path including the loaded rolling-element rolling portion, the rolling-element return path and the direction change path; and a lubricating path, provided on at least one of the cover members, for supplying a lubricant to the rolling-element circulation path, the method comprising:
forming a lubricating path piece having a lubricating path groove which constitutes the lubricating path and a cover member main body having a fitting groove for fitting the lubricating path piece therein and being split into two or more split parts at a position for cutting the fitting groove;
assembling the split parts of the cover member main body; and
fitting the lubricating path piece into the fitting groove of the cover member main body in such a manner that the lubricating path piece is placed over a joint of the split parts of the cover member main body.
